(19) United States
(12) Patent Application Publication
(10) Pub. No.: US 2006/0267780 A1
(43) Pub. Date: Nov. 30, 2006

(54) Occupant monitoring systems

(76) Inventor: Martin Charles Adams, Much Hadham (GB)

Correspondence Address: Dr Martin Adams, 2 Mill Cottages, Station Road, Much Hadham, Herts, SG10 6AU, GB

(21) Appl. No.: 11/441,030

(22) Filed: May 26, 2006

(30) Foreign Application Priority Data
May 28, 2005 (GB) GB0510889

(51) Int. Cl. G08B 23/00

(52) U.S. Cl. 340/573.1; 340/562

(57) ABSTRACT

A system for use within a space such as homes or offices and comprising one or more motion detection sensors 1, an alarm means 6, and several logic processing devices. The logic processing devices allow said system be used to monitor levels of occupant motion by comparing motion detection sensor activation patterns to one or more predetermined activation-based rules, and if any of the activation-based rules have been broken to then to signal an alarm via the alarms devices 6. The system is designed to detect situations where the occupants or occupants may be ill, injured, dead or trapped within a single room. The activation-based rules within the system are programmed such that that they remain constant for at any given time of day, or such that they vary depending on previous activation patterns.

### FIELD OF THE INVENTION

This invention relates to occupant monitoring systems that can summon assistance by means of an alarm.

### CROSS REFERENCE TO RELATED APPLICATIONS

The present application claims the benefit of a British patent application GB 0510889.9 filed on 28 May 2005, which is incorporated herein by reference.

### STATEMENT REGARDING FEDERALLY SPONSORED RESEARCH AND DEVELOPMENT

Not applicable

### BACKGROUND TO THE INVENTION

This invention relates to systems that monitor the health and well being of occupants of homes, offices and other similar spaces. This invention or inventions described herein represents a refinement of one or more inventions described in British patent application GB 0510889.9 filed on 28 May 2005.

It will be appreciated that many people live alone and may be at risk of a debilitating illness or injury in their home or offices for which they are unable or unwilling to summon assistance. This type of situation especially applies to elderly people at home. One existing and widely used solution to this problem involves the occupant of a home (for example and elderly person) wearing an alarm device around the neck and pressing the alarm if they become ill. This alarm rings remotely and will summon help. This method will fail to work, however, if the occupant forgets to wear the alarm or if they fall unconscious before pressing the alarm for some reason. Also many people may object to wearing such a device as they will not feel they are at sufficient risk to need said alarm. Also there is usually an ongoing cost associated with this type of alarm service.

Prior art relating to this area of invention includes patents U.S. Pat. No. 6,201,476, EP1172780 and GB2179186. U.S. Pat. No. 6,201,476 cites a device which must be worn by someone to be effective. It does refer to calculating the probability of a fall, but this is an essential function for the design described, and has a different purpose to the probability factor described herein. Patent EP 1172780 describes a passive system that monitors the ‘use of home infrastructure’ such as doors, but does not describe a system that detects persons just moving around or within a property without affecting said infrastructure. Patent EP 1172780 also describes using specially designed sensors that transmit their ID's to an acquisition unit. Patent EP 1172780 also defines an alarm system wherein one activation of a sensor is enough to stop an alarm being triggered, but does not allow for more sophisticated conditions that may merit an alarm and not be detected by this patent. Patent EP 1172780 also presumes the use of one rule operational at any one time within their invention. Patent EP 1172780 also does not describe a database in which to store the historic record of previous activations, or the use of rules that can be based on ‘groups’ of sensors, both of which are described herein as a way to enable more sophisticated condition monitoring. Patent GB 2179186 also defines an alarm system wherein one activation of a sensor is enough to stop an alarm being triggered, but does not allow for more sophisticated conditions that may merit an alarm and not be detected by this patent. U.S. Pat. No. 6,201,476 also presumes the use of one rule operational at any one time within their invention. U.S. Pat. No. 6,201,476 also does not describe a database in which to store the historic record of previous activations, or the use of rules that can be based on ‘groups’ of sensors, both of which are described herein as a way to enable more sophisticated condition monitoring. Neither U.S. Pat. No. 6,201,476 or EP 1172780 describe a system that is designed to be adapted from an existing burglar alarm or that can be operated concurrently as a burglar alarm and occupant monitoring alarm.

### SUMMARY OF THE INVENTION

According to this invention I propose a system for the detection and warning of reduced mobility by an occupant or occupants of a home or offices and said system being installed in said home or offices and comprising:
a. One or more motion detection sensors each of which allow detection of motion by said occupant or occupants within or between rooms of said home or offices said detection of motion arising either as a direct result of the motion of a said occupant or occupants or by virtue of the fact that said occupant or occupants has done something that is indirectly indicative of motion within said home or offices, and
b. a clock which provides time data or time and date data that can be distributed to other elements of said system and
c. a sensor activation store that stores an activation record when said detection of motion occurs said activation record relating to one of said motion detection sensors or a group of said motion detection sensors and comprising at least some reference to time of said detection of motion and said sensor activation store always retaining at the very least data for the latest activation record and
d. a sensor processing means which first interconnects to said motion detection sensors and said clock and said sensor activation store and which secondly updates said sensor activation store whenever a new detection of motion by any said sensor occurs so as to store at least the latest said activation record to occur and which thirdly ensures that individual activations of said motion detection sensors are not double counted
e. a rules store that stores one or more activation-based rules each of which first relates in some way to the activation history of one or more of said motion detection sensors and each of which is secondly designed so as to identify abnormally reduced mobility by any said occupant or
f. one or more alarm devices capable of alerting persons who can provide or summon assistance and
g. a comparison engine that first interfaces to said rules store and said sensor activation store and said clock and that secondly interfaces to said one or more alarm devices and that thirdly makes a time dependant comparison of said activation record with said activation-based rules said time dependant comparison being dependant on the current reading of said clock and having an outcome that results in the signalling of an alarm when any of said rules are broken and
h. a means for preventing false alarms when said home or offices is unoccupied or has recently become occupied said means suppressing false alarms directly by connecting to said alarm devices or indirectly by modifying the behaviour of other component elements of said system and said means comprising input devices or circuitry that provides knowledge that said home or offices are unoccupied or occupied
whereby said system allows the detection of abnormally reduced or abnormally varied mobility of said occupant or occupants (for example death or debilitating illness or injury) and then the activation of said alarm devices so as to attempt to summon assistance.

### BRIEF DESCRIPTION OF THE FIGURES

FIG. 1 is a schematic representation that shows the components of a basic embodiment of an occupant monitoring system according to this invention.

FIG. 2 is a schematic representation shows the scheme of FIG. 1 refined by additional components to provide a preferred embodiment of the invention,

FIG. 3 is a schematic representation of a two storey house that contains an occupant monitoring system as shown in FIG. 2.

FIG. 4 is a flowchart showing the interconnection of the functional processes operating in an intelligent control unit within the preferred embodiment of FIG. 2, and their linkage to data stores within the system,

FIG. 5 is a schematic representation of a sensor processing means as employed in the preferred embodiment of FIG. 2,

FIG. 6 is a flowchart showing the interconnection of functional processes operating within a sensor processing means processing engine in the control unit,

FIG. 7 is a schematic representation showing the key states of a simple counting means processing engine employed in the preferred embodiment of FIG. 2 and the events that cause transitions between states,

FIG. 8 is a schematic representation showing the key states of a preferred but more complex counting means processing engine which may be employed in the preferred embodiment and the events that causes transitions between states, and

FIG. 9 is a flowchart showing the key functional processes operating within a comparison engine processing engine in the control unit of FIG. 2 and their interconnection.

### DETAILED DESCRIPTION OF THE INVENTION

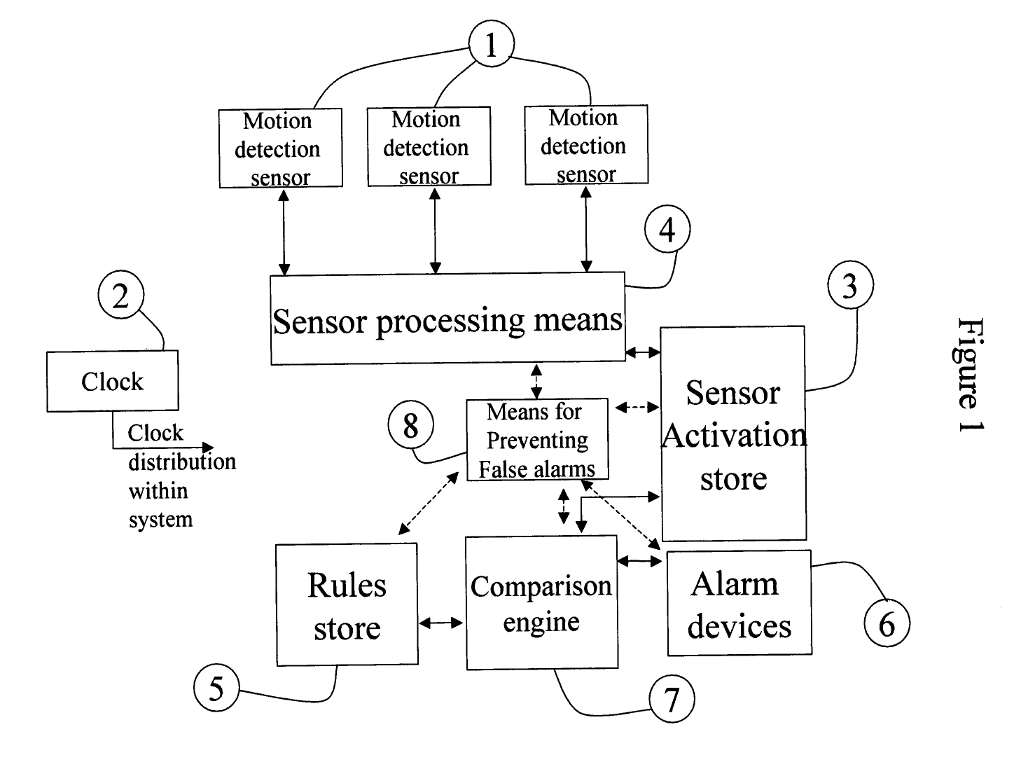

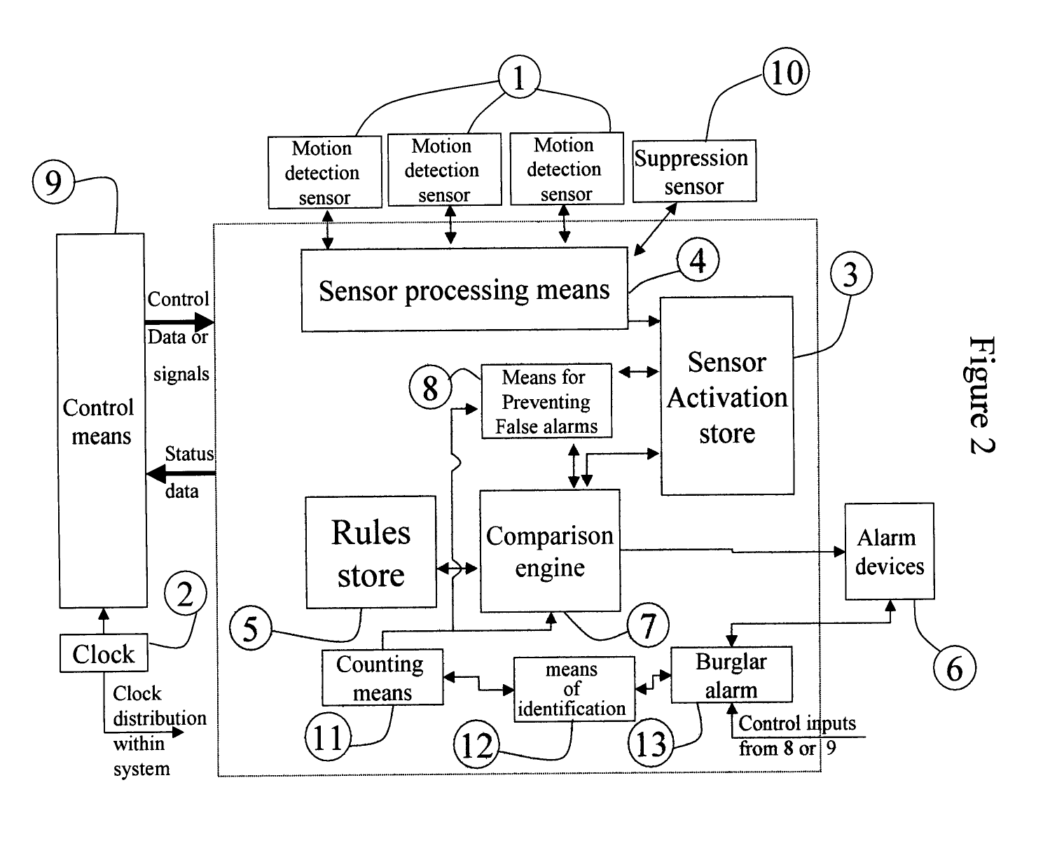

A basic embodiment of an occupant monitoring system is first described in outline with reference to FIG. 1. A preferred embodiment, which is an enhancement of the basic embodiment, is described afterwards in more detail, with reference to FIGS. 2 to 9. Throughout this description the word ‘space’ includes locations with one or more rooms such as hospitals or home or offices. Throughout this description the term motion refers to either movement of at least part of a person's body whilst the body stays in the same place, or to the movement of a person's whole body from one location to another. Throughout this description the term mobility refers throughout to the ability of a person to move their whole body from one location to another. The extent to which motion that is recognized as mobility may be determined in advance, for example during manufacture. Throughout this specification the word ‘clock’ is used to describe anything that provides information about the elapsed time or elapsed time and date since some reference point, or of the actual time or time and date. Throughout this specification the word ‘engine’ is used to describe a hardware based or software based device that performs data processing of some sort, such as a comparison, and produce an output that is dependent on that data processing. Throughout this description the term ‘system(s)’, when used without any descriptive noun or nouns preceding it, is used to describe an occupant monitoring system(s) that may or may not further comprise system elements that perform an additional burglar alarm function. Furthermore the term ‘burglar alarm system’ is used throughout to describe a system that is designed solely to detect burglars.

The basic system, as shown in FIG. 1, comprises:
a plurality of motion detection sensors 1, each of which allows detection of motion of the or each occupant within the space;
a clock 2 that provides either the actual time or time and date, said information being made available for use by other elements of the system;
a sensor activation store 3 that stores an activation record whenever said suppression sensor is activated and whenever said detection of motion occurs said activation record comprising the time and date of said detection of motion and said sensor activation store retaining data for the latest activation and for all activations that occurred for a period of a least a week prior to the current time;
a sensor processing means 4 which firstly interconnects by electrical or wireless means to said motion detection sensors and said clock and said sensor activation store and which secondly updates said sensor activation store whenever a new detection of motion by any said sensor occurs or whenever operation of said suppression sensor occurs so as to store at least the latest said activation record to occur and which thirdly ensures that activations of said sensors are not unduly double counted;
a rules store 5 to store multiple activation-based rules, each of which relates to the activation history of one of the motion detection sensors or to one of the defined groups of motion detection sensors and each of which is designed so as to help identify abnormally reduced or abnormally varied motion of a person or persons in the space;
one or more alarm devices 6 for giving an alarm for summoning assistance to the person exhibiting abnormally reduced or abnormally varied motion;
a comparison engine 7 firstly to interface with the rules store, the sensor activation store and the clock, secondly to interface with the one or more alarm devices, and thirdly to make a time dependent comparison of the activation record with the activation-based rules, the time dependent comparison being based on the current reading of the clock and having an outcome that results in the signalling of an alarm when any of the rules is broken;
a means for preventing false alarms 8 when said space is unoccupied or has recently become occupied said means suppressing false alarms directly by connecting to said alarm devices or indirectly by modifying the behaviour of other component elements of said system and said means comprising input devices or circuitry that provides knowledge that said space are unoccupied or occupied;

Further to the basic embodiment, the preferred embodiment has:
a suppression sensor 10 that is a variant of a motion detection sensor or is a switch that is designed such that it can be activated only when specifically desired by an occupant, and its activation is recognised by the invention as indication that all alarm devices 6 should be suppressed for some time that has been defined within the system;
a counting means 11 that enables a count to be stored for the number of occupants with the space, and that enables the count to be manually entered or to be automatically calculated, and that further comprises a table of logically associated motion sensors and distant sensors, as described hereinafter; and
a means of identification 12 that allows the system to identify legitimate users of the system.

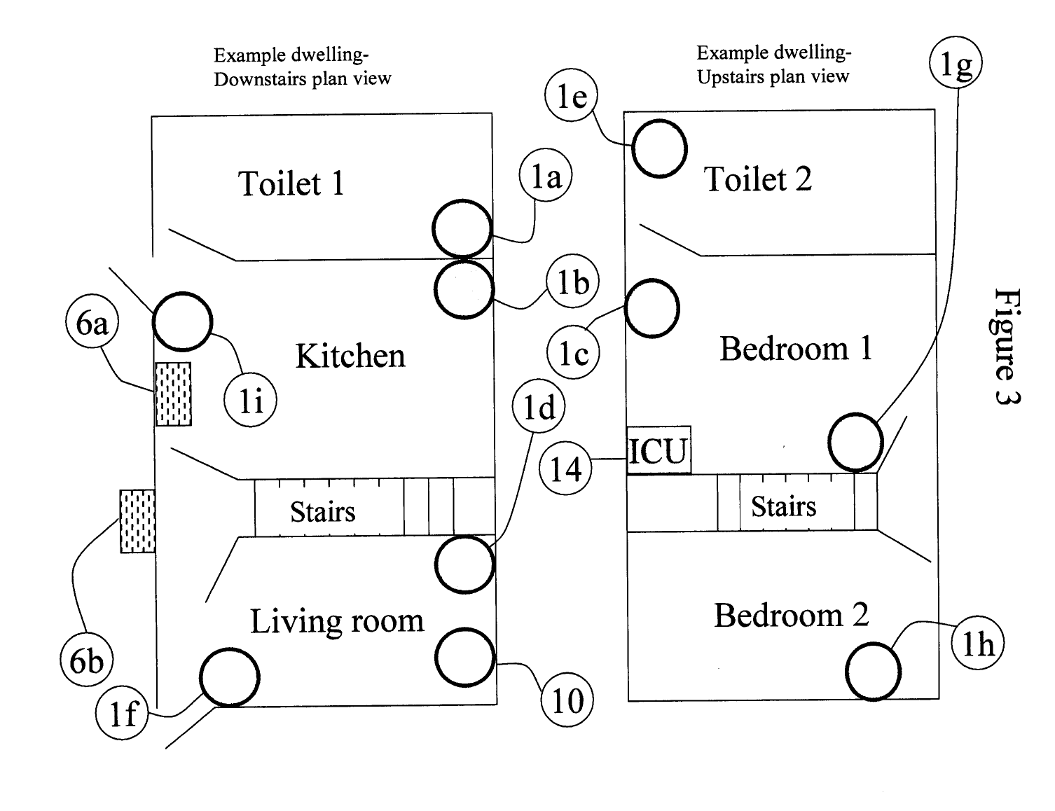

A more detailed description of this preferred embodiment of the invention now follows, said preferred embodiment being shown with reference to FIGS. 2-9. This preferred embodiment is described by way of an example as an installation in a two bedroom house as represented by FIG. 3. In this preferred embodiment all parts of the system apart from the alarm means 6, the motion detection sensors 1 and the suppression sensor 10 are all packaged in a single enclosed unit referred to hereinafter as the intelligent control unit 14. Other embodiments are feasible and practicable. One alternative embodiment, for example, would be one in which the control means 9 was removed from the intelligent control unit 14 and located elsewhere.

This preferred embodiment also comprises a burglar alarm 13 that interfaces to both the means of identification 12 and the alarm devices 6. This burglar alarm 13 as shown in this preferred embodiment represents only the main control elements of the burglar alarm as the alarm devices 6 are external and the control means 9 is presumed to be designed so to provide control of the burglar alarm 13. This burglar alarm is controlled such that it allows the comparison engine 7 and burglar alarm 13 to be operational concurrently or for just one of these to be operational at any one time as desired by the operator of the occupant monitoring system. The burglar alarm may be an already-installed domestic burglar alarm system as supplied by ADT (or other similar vendors).

This preferred embodiment of the occupant monitoring system can operate as an occupant monitoring system whilst also being able to detect certain scenarios when intruders are entering the space. When the occupant monitoring system is not operating in this dual mode it is likely than the occupant monitoring system will act an occupant monitoring system whllst legitimate occupants are in the space, and will then be switched to ‘burglar alarm mode’ when the legitimate occupant or occupants have left the space.

The detailed description of this preferred embodiment describes an example of control logic that allows the switching between the ‘burglar alarm mode’ and ‘occupant monitoring mode’. Alternative modes of switching include a manual method of switching that controls the mode of operation the occupant monitoring system is working in.

In this preferred embodiment the operation of this dual operation mode (burglar alarm and occupant monitoring system) is described in detail, although some of the logic for the burglar alarm is described as being optional. Indeed the occupant monitoring system may be purchased without the logic and hardware related to the burglar alarm to produce a slightly less expensive system that, if so desired, could be upgraded in-situ.

In this preferred embodiment the means for preventing false alarms 8 modifies the contents of the sensor activation store 3 such that it prevents false alarms in certain situations.

Lastly this preferred embodiment of the invention comprises a control means 9, which provides a way to control and configure the elements within the system and to view the status of these elements.

The intelligent control unit 14 interconnects to all motion detection sensors 1 and alarm devices 6. In this preferred embodiment the motion detection sensors 1 from FIG. 1 are given additional identifiers such that individual motion detection sensors are labelled 1a to 1i. These additional identifiers are given to help identify the location of these motion detection sensors in FIG. 3. The motion detection sensors 1a to 1e, and 1h, are motion detection sensor types that directly detect motion by an occupant and can be of various types including passive infrared detectors, ultrasonic motion detectors, optical motion detection sensors and vibration motion detection sensors. Motion detection sensors 1f and 1i are located on the space entry or exit doors and hence detect motion indirectly. Hereinafter these will be referred as external door action sensors. The motion detection sensor 1g is also of a type and location that allows it to detect the opening or closing of an internal door, and thus it detects motion indirectly. The elements of the intelligent control unit have already been described but it will be appreciated that alternative variants of the intelligent control unit 14 could exist in other embodiments if so desired. One alternative variant, for example, would be one in which the control means 9 was removed from the intelligent control unit 14 and located in an alternative location.

The motion detection sensors preferably are arranged at points around the space where they will be frequently triggered by the occupant, preferably making sure to locate some motion detection sensors at points that must be used for key bodily functions such as going to the toilet, going to make a meal or going to sleep, and making sure that there is a motion detection sensor monitoring all entry and exit doors, and making sure that the sensitivity of no motion detection sensor is so great that it will be triggered by pets.

The suppression sensor is located somewhere the occupant or occupants can easily reach it, and the intelligent control unit is located somewhere that minimises its obtrusiveness whilst ensuring that it can be accessed easily for inputting control commands and for viewing the status of the system.

Furthermore two variants of the alarm means 7 in FIG. 1 are shown, these being first an alarm means 7a that is internal to the space in FIG. 3 and secondly an alarm means 7b that is external to the space in FIG. 3.

The internal alarm 7a and the external alarm 7b can be sonic or light based alarms, or may send alarms via electronic means to devices such as telephones or computers. The internal alarm is intended to warn people inside space that an external alarm will soon be sounded and the external alarm is intended to warn people outside the space that the occupant may need assistance.

A detailed description of the various component parts of the intelligent control unit 14 in FIG. 3 is now given.

Rules Store 5

The rules store 5, like all other stores described within this invention, can be implemented as either a single contiguous store or a distributed store. It comprises a means to store activation-based rules that define when an alarm signalling condition exists. Before proceeding to describe this store it is important to describe some of the main features of the activation-based rules allowable within the invention

First the invention described herein allows that different activation-based rules can be defined for different periods of the day or different days of the week. Each of these times of day or dates that has a different rule associated with it is referred to hereinafter as a ‘defined period’.

Secondly the invention described herein also allows that activation-based rules can be made for one or more individual motion detection sensors or for groups of motion detection sensors, or for both of these things. A ‘group’ of motion detection sensors is a defined set of motion detection sensors whose location in the space means that it is particularly beneficial to aggregate the activations from this defined set, and then to compare the aggregated activation pattern against a single rule. One example of a group of motion detection sensors is one where the activations from all motion detection sensors located within a toilet are combined together such that they are treated as they were from a single motion detection sensor located within the only toilet in space. Another example of a ‘group of motion detection sensors’ is one where all the motion detection sensors within the invention are treated as they were acting as a single motion detection sensor that was able to monitor most or all activity within the space, and any activation from any motion detection sensor is compared to the single activation rule applying to that group. Other examples of groups of motion detection sensors are groups of motion detection sensors that are associated with one of the following locations or features within the space:
Located in all places where occupants go for a wash
Located in all places where the occupant might go to sleep in any bed
Located such that they monitor all entry and exit doors

Another example of an activation-based rule affecting a ‘group of motion detection sensors’ is an activation-based rule that is applied to a group consisting of all motion detection sensors within the invention and which just checked for an activation of any two different motion detection sensors within this group within defined time, frequency or probability constraints. This rule allows confirmation that an occupant or occupants is mobile enough to travel between motion detection sensors.

Thirdly the invention described herein also allows that any given motion detection sensor can be associated with more than one rule.

Fourthly the rules store 5 allows for a multiplicity of different alarm conditions to be established and to run concurrently.

Fifthly it is possible to have an invention where only one rule exists within the invention, thus making the invention easier to configure and manage. An effective implementation of the invention, for example, can be constructed using just one rule. This might be an activation-based rule that applied to a single grouping of all motion detection sensors within the invention and which just checked for an activation of any of these within defined time, frequency or probability constraints. Another effective implementation of the invention could also be constructed using just one rule this being an activation-based rule that applied to a single grouping of all motion detection sensors within the invention and which just checked for an activation of any two different motion detection sensors within this group within defined time, frequency or probability constraints. This last described implementation of the invention checks that an occupant or occupants is mobile enough to travel between motion detection sensors.

Sixthly the activation-based rules can also be modified dependent on the number of occupants considered to be within the space, said occupancy level being a value that can be stored in the preferred embodiment of the invention.

Seventhly activation-based rules can be added, deleted or modified within the invention, by means of the control means 9. Alternatively activation-based rules can exist within the invention but they be put in to a disabled state by attaching an appropriate marker to the rule. In the embodiment of the invention described herein a disabled rule is one where the value ‘99’ is entered in to the defined period field F101 of Table T1 (Table T1 is described later in this text).

This text now proceeds to describe the rules store 5. In this preferred embodiment of the invention the rules store 5 comprises a means of interfacing to the Comparison engine 7, the clock 2 and the control means 9, and it further comprises of two tables of data whose contents can be written to or read by the Comparison engine 7 and the control means 9. The two tables of data are Table T1 and Table T2, which are described in more detail below. Table T1 defines the general activation-based rules relating to the motion detection sensors. Table T2 defines the activation-based rules relating to a more specific ‘simple and repeating activation pattern’ that enables an occupant to deliberately invoke an alarm. The activation-based rules defined within Table T1 are described first, and then the rule defined within Table T2.

Table T1 is shown below.

TABLE T1
Table of rules

| | | | | Limit 1 (Concern) | Limit 2 (Danger) |
|---|---|---|---|---|---|
| | | | | The limit which | The limit which |
| | | | Unit of measure | when exceeded | when exceeded |
| | Name of Register | Defined | for the set limits | will signal an | will signal an |
| | and sensors the | period | called ‘limit 1’ | event of some | event of potential |
| Register | register relates to | (Field | and ‘limit 2’ | concern | danger |
| ID | (Field ID = F100) | ID = F101) | (Field ID = F102) | (Field ID = F103A) | (Field ID = F104A) |
| R51-DP1 | Sensor 1a | 1 | Activations per | 3 | 0 |
| | standalone, 1a | | period | | |
| R51-DP2 | Sensor 1a | 2 | Activations per | 0 | 0 |
| | standalone, 1b | | hour | | |
| R52 | Sensor 1b | 0 | Adaptive rule | Below 5% | Below 3% |
| | standalone, 1c | | setting | probability | probability |
| R53 | Sensor 1c | 99 | Activations per | 0 | 0 |
| | standalone, 1d | | hour | | |
| R54 | Sensor 1d | 99 | Activations per | 2 | 0 |
| | standalone, 1e | | period | | |
| R55 | Sensor 1e | 99 | Activations per | 0 | 1 |
| | standalone, 1e | | hour | | |
| R56 | Sensor 1f | 99 | Activations per | 0 | 0 |
| | standalone, 1f | | period | | |
| R57 | Sensor 1g | 99 | Activations per | 0 | 0 |
| | standalone, 1g | | period | | |
| R58 | Sensor 1h | 99 | Activations per | 0 | 0 |
| | standalone, 1h | | period | | |
| R58 | Sensor 1i | 99 | Activations per | 0 | 0 |
| | standalone, 1i | | period | | |
| R60 | Sensor 10 | 99 | Activations per | 0 | 0 |
| | standalone, 10 | | period | | |
| R70 | Sleep sensor limits, | 0 | Hours since last | 13 | 16 |
| | 1c, 1g, 1h | | activation | | |
| R71-DP1 | Toilet sensor | 1 | Activations per | 7 | 2 |
| | limits, 1a, 1e | | period | | |
| R71-DP2 | Toilet sensor | 2 | Activations per | 2 | 0 |
| | limits, 1a, 1e | | period | | |
| R72-DP1 | Wash sensors | 1 | Activations per | 3 | 1 |
| | limits, 1a, 1e, 1b | | period | | |
| R72-DP2 | Wash sensor limits, | 99 | Activations per | 1 | 0 |
| | 1a, 1e, 1b | | period | | |
| R73 | External door | 0 | Activations per | 1 | 0 |
| | action sensor | | period | | |
| | limits, 1f, 1i | | | | |

Each table described for this invention is structured such that it contains a number of ‘fields’ that contain data. Each field is given a unique identifier that begins with the letter F. Some tables additionally contain ‘registers’ which are given a register ID that begins with the letter R. In this case each register has a number of fields associated with it, but the value for each field can vary dependent on the register ID. In some cases the register ID also comprises a suffix. A suffix in the format ‘DP1’ is added to the register ID only in cases where the register represents just one part of an activation-based rule for a motion detection sensor or group of motion detection sensors. The ‘DP’ part of the suffix denotes that the register defines an activation-based rule for one specific defined period, and the number after the letters ‘DP’ defines the defined period in question. For example the cells in the row associated with Register R51-DP1 in Table T1 define an activation-based rule that applies to motion detection sensor 1a during the defined period number 1, and the cells in the row associated with register R51-DP2 defines an activation-based rule that applies to motion detection sensor 1 during the defined period number 2. The contents of each table can be written to and read by data processing engines within the invention, either by electronic, electrical or software means.

The first column in Table T1 allows identification of the different registers, whilst the other columns define the various fields of these registers. The number of registers defined in the first column of Table T1 is configurable via the control means, and can be varied to suit the space in which the invention is installed. Each row in Table T1 (apart from the heading rows) represents an activation-based rule for a motion detection sensor or a group of motion detection sensors, or it represents a part of an activation-based rule that applies to one defined period for that motion detection sensor or group of motion detection sensors. One activation-based rule to note is that defined by registers R74-DP1 and R74-DP2 in Table T1 which define limits for all motion detection sensors acting as a group of motion detection sensors. An activation of any motion detection sensor within this group of motion detection sensors will count as a valid activation when being compared against the respective rule for that register. Another activation-based rule to note is that defined by register R75 in Table T1 which defines limits for all motion detection sensors acting as a group of motion detection sensors, but which requires the activation of any two different motion detection sensors within the group of motion detection sensors. This activation-based rule is intended to cater for the situation where a person may be trapped in a single room and so is able to activate a single motion detection sensor, but might not be able to activate two different motion detection sensors. The rule defined in register R75 would ensure an alarm was signalled in this event, when a second motion detection sensor was not activated within the confines of the activation-based rules.

Field F100 in Table T1 is simply a text description of the motion detection sensor or group of motion detection sensors to which each rule applies.

Field F101 in Table 1 stores a value indicative of the defined period to which this register applies, a ‘zero’ value signifying that no defined period has been applied and the associated activation-based rules therefore applies to the latest 24 hour time period. A value of ‘99’ in this field indicates that the rule has been disabled.

Field F102 defines the measurement units that are used in fields F103A and F104A (and any fields with the same purpose but designed for different occupancy levels) to define the activation-based rules. By way of an example of these measurement units a first way of defining an activation-based rule for a motion detection sensor is to define a minimum number of activations per hour that will prevent an alarm being sounded. A second way of defining an activation-based rule for a motion detection sensor is to define a minimum number of activations per defined period that will prevent an alarm being sounded. A third way of defining an activation-based rule for a motion detection sensor is to define the maximum acceptable delay between activations per defined period that will prevent an alarm being sounded. A fourth way of defining an activation-based rule for a motion detection sensor is in terms of the probability of an activation delay that is considered to constitute a threshold value. In order to explain this more clearly consider the case in which a given motion detection sensor has not been activated for the past three hours, and that reference to previous activation history indicates there is only a 2% chance of this three hour delay in activation occurring. In this event we may have set an activation-based rule that requires an alarm to be signalled at a probability level of 3% or below, and so an alarm would be signalled. This fourth method of defining an activation-based rule presumes some method exists of analysing previous activation patterns and using these to calculate the probability of the current activation pattern. There are many well known methods of pattern matching that will work satisfactorily in this situation. Pattern matching methods are widely described, one example being the book titled ‘Pattern recognition and Image analysis’ (ISBN 0132364158). This fourth way of defining activation-based rules based on probability will hereinafter be referred to as ‘adaptive rule setting’ to easier reference within the text.

Fields F103 and F104 contain the values which define the activation pattern that will trigger an alarm, field F103 storing a value (called limit 1 in this text) to define a lower alarm threshold than field 104 (called limit 2 in this text), and thus allowing two different alarm conditions to be recognised and signalled. The general convention used within this preferred embodiment of the invention is that an activation-based rule is considered broken if the activation level has not been high enough to match the numbers defined in fields F103 and F104. A feature of this invention is that it is possible to remove one of the fields F103 or F104 if so desired. One further feature is that additional fields similar to field F103 or F104 can be defined within the invention with a view to better identifying different types of alarm conditions and providing more customised alarm signals. Another further feature is that for each field F103 or F104 (and the additional fields just described) there can be additional fields that are intended to define modified alarm thresholds for different occupancy levels. For example field F103A can define the limit 1 when the occupancy level was 1 person, field F103B would define the limit 1 when the occupancy level was 2 persons, field F103C would define the ‘concern’ alarm when the occupancy level was 3 persons etc. It is a feature of the preferred embodiment that additional fields be defined for different occupancy levels, but in any further description of this preferred embodiment it is presumed that the alarm thresholds are not modified by the occupancy level. This means that there will be little reference to fields F103A, F104A etc in the remainder of this text.

Table T2, shown below, defines activation-based rules that enable the invention to recognise situations when an occupant is deliberately causing a specific motion detection sensor pattern, this pattern being generated at any one single motion detection sensor within the invention, with the objective of invoking an alarm. An occupant might want to do this if they were trapped for some reason, and was only able to activate just one motion detection sensor. This simple and repeating pattern could be any pattern that is easy to generate by an occupant, but which is such that it is unlikely to occur in normal day-to-day life. An example might be where six activations had occurred in a short period of time such as twelve seconds. Another example might be where six activations had occurred consecutively with an average delay of three seconds between each activation. Table T2 is structured such that it that it allows two different values. This is done so that the user can select one of two methods of defining the ‘simple and repeating activation pattern’, and these two methods are referred to as ‘option one’ or ‘option two’. In the example in table T2 option one defines a pattern of six activations within twelve seconds, and any such pattern would generate an alarm. Likewise table T2 option two defines an alarm pattern that is six activations with an average interval of three seconds between activations.

TABLE T2
Definition of ‘simple and repeating activation pattern’

| | Number of | | Average interval |
|---|---|---|---|
| | activations | Defined period | between activations |
| | Field ID = F106 | Field ID = F107 | Field ID = F108 |
| Table | 6 | 12 seconds | |
| T2-Option | | | |
| one | | | |
| Table | 6 | | 3 |
| T2-Option | | | |
| two | | | |

Sensor Activation Store 3

In this preferred embodiment of the invention the sensor activation store 3 comprises a means of interfacing to the Comparison engine 7, the means for preventing false alarms 8, the clock 2, the control means 9, and the Sensor processing means 4. It further comprises several tables of data. These said several tables of data comprise:
One instance of a table formatted like table T3 for every motion detection sensor or switch within the invention. Each table like this is given a unique register ID and comprises four data fields that are identified as fields F110 to F113. The register ID's are given values R1a, R1b, R1c etc depending on which motion detection sensor they relate to. For example register R1f stores values that relate to the activation of motion detection sensor 1f within FIG. 3. Each of the individual registers formatted like table 3, when combined together, form ‘part a’ of the sensor activation store 4. The purpose of the fields F110 to F113 is described within Table 3 below, under the column headed ‘purpose of the field’.
One table T4 that stores data relating to the activation of specific classes of motion detection sensors, as described within the table below. This table is referred to as ‘part b’ of the sensor activation store 3, and contains fields F114 to F115. The purpose of each of these fields is described within table T4.

These tables T3 and T4 are shown below:

TABLE T3
Format of one of the registers within part a of the sensor activation store 3

| Field or | | | Data that is |
|---|---|---|---|
| register | | | stored (for |
| ID | Name of Field | Purpose of the field | example) |
| R1a | Sensor ID | This is a unique identifier which enables the Table below to | R1a |
| | | be associated with a specific sensor. In this example the | |
| | | values within the Table would apply to sensor 1a. This sensor | |
| | | specific Table would be referred to in the main text as | |
| | | register 1a. | |
| F110 | ‘Time sensor | This records the time at which this sensor became active in | 1^{st} December |
| | became active’ | the system. This field is present in case this information | 2003, |
| | | assists in calculating the reliability of any alarm decisions | 120000 |
| | | based on activation records from this sensor. Format is date | |
| | | and time (hhmmss i.e.hours, minutes, seconds) | |
| F111 | Time of last | This records the time that the sensor was last activated. | 3^{rd} December |
| | activation | Format is date, hhmmss | 2003, 150003 |
| F112 | Historic | For each sensor this stores data on the time and date of past | 3^{rd} December |
| | activation | activations. This data is used when an understanding of | 2003, 130303, |
| | record | previous activation patterns is required within the invention. | 3^{rd} December |
| | | Format is date, hhmmss, date, hhmmss, date, hhmmss etc | 2003, 142003 |
| F113 | Compensation | This records a record of ‘dummy’ sensor activations. These | 0 |
| | activation | dummy activations are used to make allowance for the lack | |
| | record | of activations when the premises is empty, and assists in | |
| | | reducing false alarms. Format is a simple number. | |

TABLE T4
Part b of the sensor activation store 3

| Field or | Data that is | | |
|---|---|---|---|
| register | stored (for | | |
| ID | example) | Name of Field | Purpose of the field |
| F114 | 1a, 3^{rd} December | Time and date | This stores the time and date of the activation of the |
| | 2003, 152003 | any sensor was | last sensor to be activated. Data format is sensor ID, |
| | | last activated | date, hhmmss. |
| F115 | 3^{rd} December | Time since | This stores the time at which the suppression sensor |
| | 2003, 121000 | suppression | was last activated. Previous records of activation times |
| | | sensor was last | may ly be stored if required as information by the |
| | | activated | user. Data format is date, hhmmss. |
| F116 | 1f, 3^{rd} December | Latest time and | This stores the time at any entry or exit sensor was last |
| | 2003, 150013 | External door | activated. Data format is sensor ID, date, hhmmss. |
| | | action sensor was | |
| | | activated | |

The Clock 2

The clock 2 is of such a type that it can distribute time and date information to other processing elements of the invention. It is most likely that this clock will be an electronic clock. Preferably this clock 2 will be adjusted such that it stores a time and date value that is correct, but this is not an essential feature of the invention. The clock 2 may optionally be attached to a separate light motion detection sensor that has visibility to the outside daylight, and which can use internal logic to calculate the correct time of day to within a few hours based on the patterns of light and dark. This attachment will help reduce false alarms caused by significant errors in the time of day, but is not essential.

Overview of the Data Processing Routines with the Preferred Embodiment

Various data processing routines operate within the preferred embodiment. A different processing engine is responsible for each routine, and these processing engines are contained within the control means 9, the sensor processing means 4, the Comparison engine 7 and the alarm devices 6.

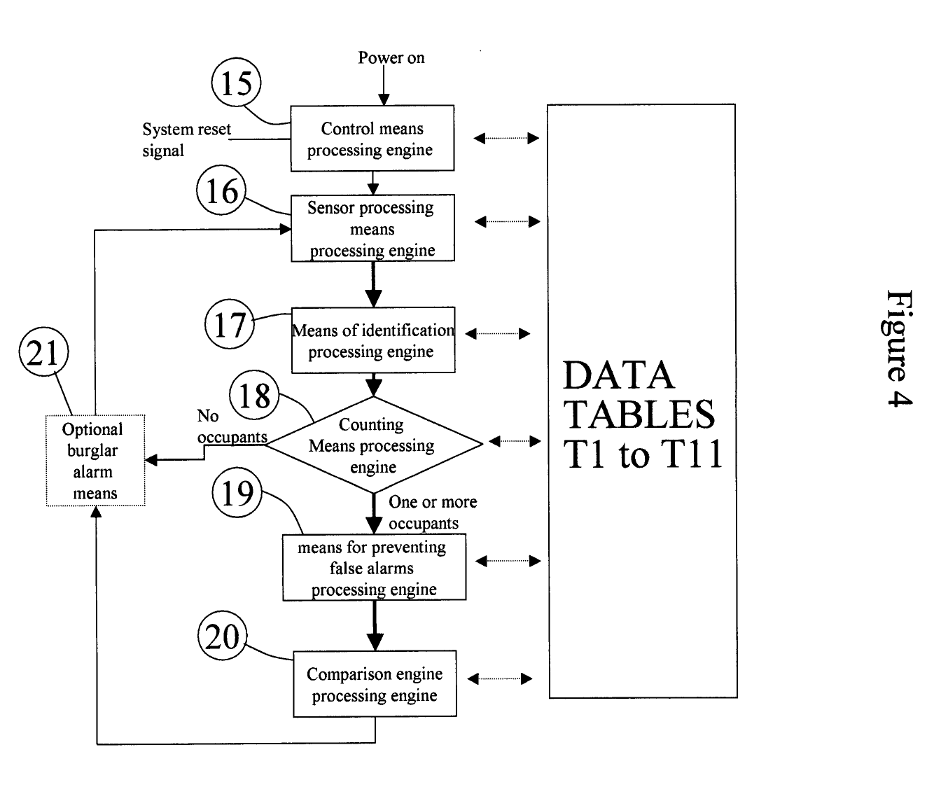

The processing engines within this preferred embodiment are described with reference to the flowchart in FIG. 4, and they are as follows:

The control means processing engine 15

The sensor processing means processing engine 16

The means of identification processing engine 17

The counting means processing engine 18

The means for preventing false alarms processing engine 19

The Comparison engine processing engine 20

The optional burglar alarm means processing engine 21

FIG. 4 shows the way that processing is transferred from one processing engine to the next. This transfer can be arranged by logic within each processing engine, or by central control from the control means 9. FIG. 4 also shows that these processing engines read and write data from and to one or more of the data stores previously described. In the implementation of the invention as described here each of the processing engines 15 to 20 is designed to operate quickly such that the whole cycle of processing allows continual monitoring of motion detection sensor activations. The optional burglar alarm means processing engine 21 is not described in any detail here, but if the invention is running such that it is operating as both a motion detection system and a burglar alarm system then the optional burglar alarm means processing engine 21 shall be designed such that it does not prevent the efficient operation of processes performed by processing engines 15 to 20.

Each of these processing engines will now be described in more detail, as a part of the description the important functional means within the invention.

Control Means 9

The control means 9 allows people to configure the operational parameters of the invention, either directly or via intermediate equipment. The control means also ensures initialisation of the invention such that no alarms are signalled just after initialisation or invention reset. The control means also allows people to observe or download configuration and status data from within the invention.

Examples of these configurable operational parameters include:
Changing alarms volumes and duration
Modifying activation-based rules
Modifying stored values for the ‘means of identification 12’, to change values relating to the identification of legitimate users of the invention
Adding, deleting, or disabling motion detection sensors
Storing values which record the time any motion detection sensor became active in the system

The control means comprises of the interface hardware required to communicate to the person or equipment configuring the invention, and this can include:
Mechanical keypads for data entry, including the entry of a predetermined secret code in order to identify legitimate users of the invention
Means of data display such as LEDs, LCDs or a visual display unit
Electronic interface systems so that communication can be made to external electronic equipment

The control means also comprises the interface hardware required to communicate with and control other elements of the invention.

The control means also comprises the control means processing engine 15. This control means processing engine 15 performs the data handling routines required to transfer control and configuration data from the invention to the person or equipment controlling the invention. This control means processing engine 15 also performs the data handling routines required to transfer control and configuration data from the person or equipment controlling the invention to the various controllable elements within the invention. This control means processing engine 15 also performs any additional data processing required to ensure the data being transferred between the person or equipment controlling the invention and the various controllable elements within the invention is formatted as required.

The control means also comprises a data store as shown in table T5. This stores a range of data needed for the general configuration and control of the invention described, and the data is described within the table T5 below.

TABLE T5
Data store for the control means 9

| | Column where a | | |
|---|---|---|---|
| Field ID | value is stored | Name of Field | Purpose |
| F120 | D | Burglar alarm | This defines if the system is acting as a burglar alarm |
| | | mode | whilst the building is empty. Options are ‘n’ = no, ‘Y’ = yes |
| | | | or ‘D’ = dual mode (burglar alarm and motion detection |
| | | | mode |
| F121 | 7a | Internal alarm | This records the ID value of the internal alarm/alarms |
| | | ID | |
| F122 | 7b | External alarm | This records the ID value of the external alarm/alarms |
| | | ID | |
| F123 | 1a, 1b, 1c, 1d, 1e, 1f, 1g, | Sensors active | This records the ID's of those sensors which are defined |
| | 10 | | as being active in the system. |
| F124 | 10 | Suppression | This records the ID's of sensors or switches which is/are |
| | | sensor ID | acting as the suppression sensors |
| F125 | DP1 = 0800-2000, | Defined periods | This one or more ‘defined periods’ and assigns each |
| | DP2 = 2001-0759 | | defined period an ID that can be referred to in register |
| | | | R12. A period can be defined in absolute terms (e.g one |
| | | | defined period might be from 12 am to 12 pm), or it an be |
| | | | defined in relative terms (e.g. one defined period might be |
| | | | ‘anytime within the last 12 hours’) |
| F126 | 0010 | Standard sensor | This defines the minimum elapsed time between any |
| | | blackout period | sensor being activated and the sounding of an alarm |
| | | | condition. This is in hhmm format |
| F127 | 0100 | Suppression | This defines the minimum elapsed time between the |
| | | sensor blackout | suppression sensor being pressed and the sounding of an |
| | | period | alarm condition. This is in hhmm format |
| F128 | 0030 | Internal alarm | This defines the maximum period the internal alarm is |
| | | sounding period | allowed to sound before the external alarm is triggered. |
| | | | This is in mmss format |
| F129 | 010012 | Internal alarm | This defines the actual time the internal alarm started |
| | | initiation time | sounding. This is in hhmmss format. |
| F130 | 0030 | External alarm | This defines the maximum period the external alarm is |
| | | signalling period | allowed to sound before the external alarm is modified to a |
| | | | more publically acceptable mode, such as the use of only a |
| | | | visible alarm. This is in hhmm format. |
| F133 | 2^{nd} December | External alarm | This defines the actual time at which the external alarm |
| | 2003, 120000 | initiation time | last started signalling. This is in date, hhmmss format. |
| F134 | 0600 | Long term alarm | This defines the maximum period the long term alarm is |
| | | signalling period | allowed to sound before the alarm is switched off |
| | | | completely. This is in hhmm format. |
| F135 | Option 1 | Choice of | This selects the type of ‘simple and repeating pattern’ that |
| | | ‘simple and | is to be used. |
| | | repeating | |
| | | pattern’ | |

Sensor Processing Means 4

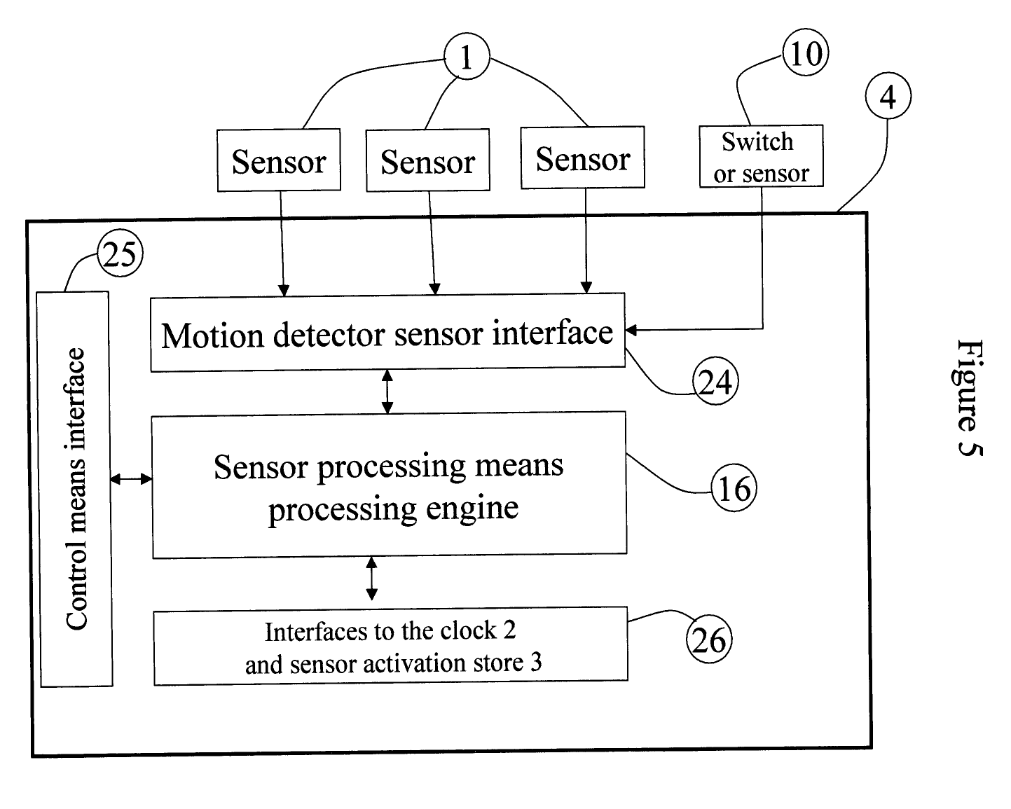

The sensor processing means 4 is shown schematically in FIG. 5 and comprises of a motion detection sensor interface 24, a sensor processing means processing engine 16, a control means interface 25, and an component called ‘Interfaces to the clock 2 and sensor activation store 3’ 26.

The motion detection sensor interface 24 receives inputs from the various motion detection sensors and if required it conditions these into an electrical format that is suitable for the processor function block. This may involve regeneration of signal levels, modification to signal levels, or the conversion of a signal of one form (such as the detection of a relay closure) into another form (for example a TTL or CMOS compatible output signal). The implementation of the invention as described within this detailed example presumes the data processor engine polls the motion detection sensor outputs, and therefore requires any signals output by the motion detection sensors to be maintained until polling is complete. For this reason and for some motion detection sensor designs the motion detection sensor interface 24 may be required to modify a short lived signal from the motion detection sensor so that a longer duration signal is output to the data processor engine. It is clearly possible, if desired, to design the sensor processing means processing engine 16 in an alternative manner such that the motion detection sensors are not polled, but rather that their activation initiates some means of recording that activation. Once a motion detection sensor has been activated and has been polled by the data processor engine it is necessary to have some means to ensure that one long activation signal is not counted as multiple separate activations. This is a relatively minor implementation matter and the solution to this is not described here. This feature is however, presumed to be in operation within this embodiment of the invention.

The control means interface 25 provides any functionality required to link any controllable elements within the sensor processing means 4 to the control means 9. [0065]

‘Interfaces to the clock 2 and sensor activation store 3’ 26 provides any functionality required to link the sensor processing means processing engine 16 to the clock 2 and the sensor activation store 3.

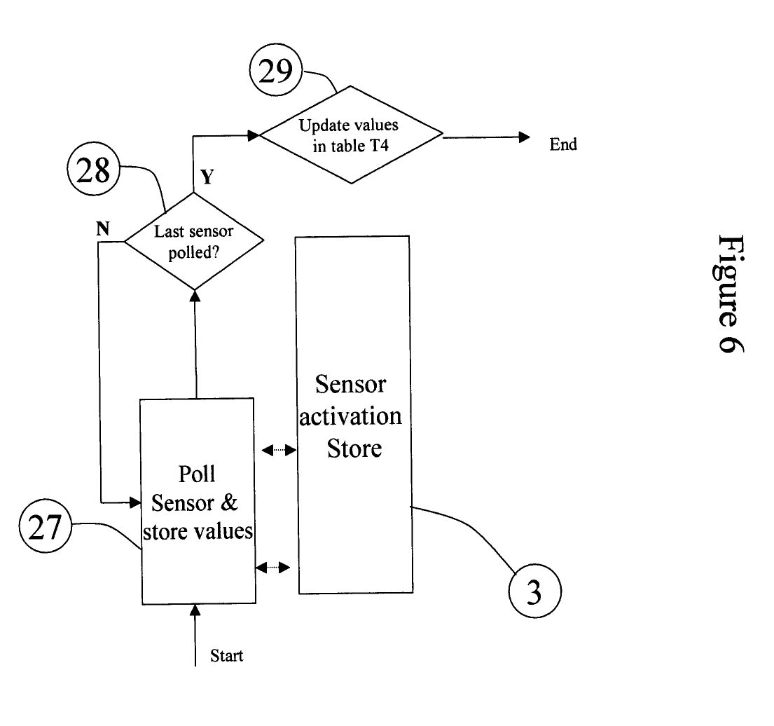

The processing means processing engine 16 implements three different processes that enable it to analyse the motion detection sensor outputs and to process these as required, and then to store an appropriate value in the Sensor activation store 3. The processes that run within the processing means processing engine 16 are shown schematically in FIG. 6.

On its first pass the first process 27 begins by reading field F123 in Table T5 to determine the identity of the motion detection sensor with the lowest ID value. The first process 27 then polls that motion detection sensor output and decides if that motion detection sensor has been activated since the last time this process was run. If this is not the case the process 27 completes and the next process to be run is process 28. If process 27 did discover a new activation of a motion detection sensor then process 27 next downloads the current time and date from the clock 2. Process 27 then stores the time and date and the motion detection sensor activation record in field F111 in the instance of Table T3 that applies to that motion detection sensor (registers R1a, R1b etc). In updating the appropriate instance of Table T3 the process 27 also ensures that the pre-existing value in field F111 of Table T3 is transferred to field F112 of the instance of Table T3 that applies to that motion detection sensor. This is in order to maintain the historic record of activations. Having completed this task process 27 ends and process 28 begins.

Process 28 checks if this last motion detection sensor checked was the last active motion detection sensor in the invention as defined by the value in field F123 of Table T5, and if not it repeats process 27 on the next active motion detection sensor until all motion detection sensors have been polled. Once all active motion detection sensors have been polled the sensor processing means processing engine 16 has completed the processing required of it.

Process 29 runs when process 28 has completed. Process 29 calculates the most recent sensors to be activated, doing this for three classes of sensors. The resulting values are stored in table T4.

Means of Identification Processing Engine 17

This processing engine comprises of interfaces to the counting means 11, to the clock 2, and to the burglar alarm 13. It also comprises of some method of allowing a person to enter some method of identification, so as to allow the system to identify legitimate occupants. This method can be by the provision of a keypad to enter a secret code, by some method of biometric identification such as voice recognition, or by any other appropriate means.

The means of identification processing engine 17 also comprises a table of data that stores the results of at least the last attempt for an occupant to identify themselves. This table T6 is shown below.

TABLE T6
Means of identification table of data

| Field | | | |
|---|---|---|---|
| ID | Value | Name of Field | Purpose |
| F145 | 1234 | unique identifier | This stores a value or alphanumeric string for a |
| | | | unique identification means that allows |
| | | | identification of legitimate users of the invention. |
| | | | The format of this is dependent on the means of |
| | | | identification used. |
| F146 | Y | Last attempt | This stores a Yes or No value to record if the last |
| | | valid? | attempt to enter a means of identification was |
| | | | valid |
| F147 | 110336, 2^{nd} | Time of last | This stores the time and date of the last attempt to |
| | December 2003 | attempt | enter a means of identification. This is in |

The purpose of the means of identification processing engine 17 is to discriminate between legitimate occupants and intruders.

Counting Means 11

The counting means 11 provides a manual and an automatic means to store the number of occupants present within the premise and a second way to notify the invention if the space is unoccupied. The counting means 11 comprises some means of manually entering a count, such as an alphanumeric keypad, a voice recognition system, or any other appropriate data entry method. The counting means 11 also comprises an interface to the Comparison engine 7, to the clock 2, to the means for preventing false alarms 8, and to the control means 9. The counting means 11 also comprises a counting means processing engine 18 and two tables of data. These tables of data are tables T7 and T8 that are shown below.

TABLE T7
Counting means (First table of data) - The occupant count

| Field ID | Value | Name of Field | Purpose |
|---|---|---|---|
| F148 | 2 | Occupant count | This field records the automatically counted |
| | | (automatic) | occupant count |
| F149 | 100336, 2^{nd} | Time & date of | This stores the time & date at which the last |
| | December 2003 | last automatic | automatically counted value was updated. This is |
| | | count | in date, hhmmss format. |
| F150 | 1 | Occupant count | This field records the manually counted occupant |
| | | (manual) | count |
| F151 | 101340, 2^{nd} | Time & date of | This stores the Time & date at which the last |
| | December 2003 | last manual | manually counted value was updated. This is in |
| | | count | date, hhmmss format. |
| F152 | F150 | Which field | This identifies which of the two counted values |
| | | stores the valid | should be used |
| | | count | |
| F153 | 2, 100312, 2^{nd} | Historic record | This stores previous values of fields F148 and |
| | December 2003, | of automatic | F149. Each entry is format in format: |
| | 1, 071312, 2^{nd} | occupant count | Occupant count, hhmmss, date |
| | December 2003 | | |
| F154 | 1, 100342, 2^{nd} | Historic record | This stores previous values of fields F150 and |
| | December 2003, | of manual | F151. Each entry is format in format: |
| | 2, 071512, 2^{nd} | occupant count | Occupant count, hhmmss, date |
| | December 2003 | | |

TABLE T8
Counting means (Second table of data)-‘logically associated motion
sensors’ and ‘distant sensors’

| | | Logically associated | Logically associated |
|---|---|---|---|
| | Distant sensor | external door action | external door action |
| | activated next to | sensor which, if | sensors which, if |
| | last, and hence | activated shortly | activated shortly |
| | denoting that | before the last | after the last |
| | there must be at | activation, will | activation will |
| Motion detection | least two | denote someone has | denote someone has |
| sensor that was | occupants within | recently entered the | recently left the |
| activated last | the building. | building | building |
| 1a | 1c, 1d, 1e, 1g, 1h, | | |
| | 10 | | |
| 1b | 1c, 1e, 1g, 1h | 1i | 1i |
| | | (1i and 1b are | (1i and 1b are |
| | | logically associated) | logically associated) |
| 1c | 1a, 1b, 1d, 1h, 10 | | |
| 1d | 1a, 1c, 1e, 1h | 1f | 1f |
| | | (1f and 1d are | (1f and 1d are |
| | | logically associated) | logically associated) |
| 1e | 1a, 1b, 1d, 1g, 1h, 10 | | |
| 1f | | | |
| 1g | 1a, 1b, 1d, 1e, 10 | | |
| 1h | 1a, 1b, 1c, 1e | | |
| 1i | | | |
| 10 | 1a, 1b, 1c, 1e, 1g, | 1f | 1f |
| | 1h | (1f and 10 are | (1f and 10 are |
| | | logically associated) | logically associated) |

The text within T7 explains the purpose of this table, whilst Table T8 is explained later in this section.

The manual means of counting requires someone to manually entering this data via an appropriate interface within the counting means 11.

The counting means processing engine 18 first interrogates the manual interface to see if anyone wishes to enter a manual count and if so it allows this to happen. The counting means processing engine 18 then transfers the existing values in fields F150 and F151 into field F154, so as to keep a historic record of previous activations. Next the new occupant value is stored in field F150 of table T7 and the corresponding time is stored in field F151.

The second process of the counting means processing engine 18 is to calculate an automatic count, if there have been any recent activations of the motion detection sensors that provide information that allows this. In order to do this the counting means processing engine 18 runs several processes that require information about the logical association of three categories of motion detection sensors the first of these being the category of motion detection sensors that comprises of those sensors that detect the opening and closing of external doors—these are referred to as external door action sensors. The second category is a categories of motion detection sensors that are located close to these external door action sensors and which by virtue of their location will always be activated just before or just after an external door action sensor—these are referred to as door proximity sensors. External door action sensors and door proximity sensors whose activations can be linked will be referred to as ‘logically associated motion detection sensors’ to aid explanation in the text. The third category of motion detection sensors are those that are not external door action sensors and which are located such that if any two motion detection sensors in this category are the last two motion detection sensors to be activated it must mean there are two or more occupants in the space. To aid explanation in the text this third category of motion detection sensors will be referred to as ‘distant sensors’. This last group can be better understood by referring to the example space in FIG. 3, and by assuming that motion detection sensors 1a and 1e were the last two motion detection sensors to be activated. It will be appreciated that a single person could not have achieved this activation pattern, as they would also have had to pass motion detection sensors 1b, 1g, and 1c. Hence in this example it would be reasonable to assume that there are at least two occupants in the space. In this example the motion detection sensor 1a is able to act as a distant motion detection sensor when combined with an activation of motion detection sensor 1e. It will be realised that some motion detection sensors can be members of more than one of these three categories just described. In this preferred embodiment of the invention the Table T8, shown below, stores a list of the three groups of motion detection sensors just mentioned and information about how they are associated.

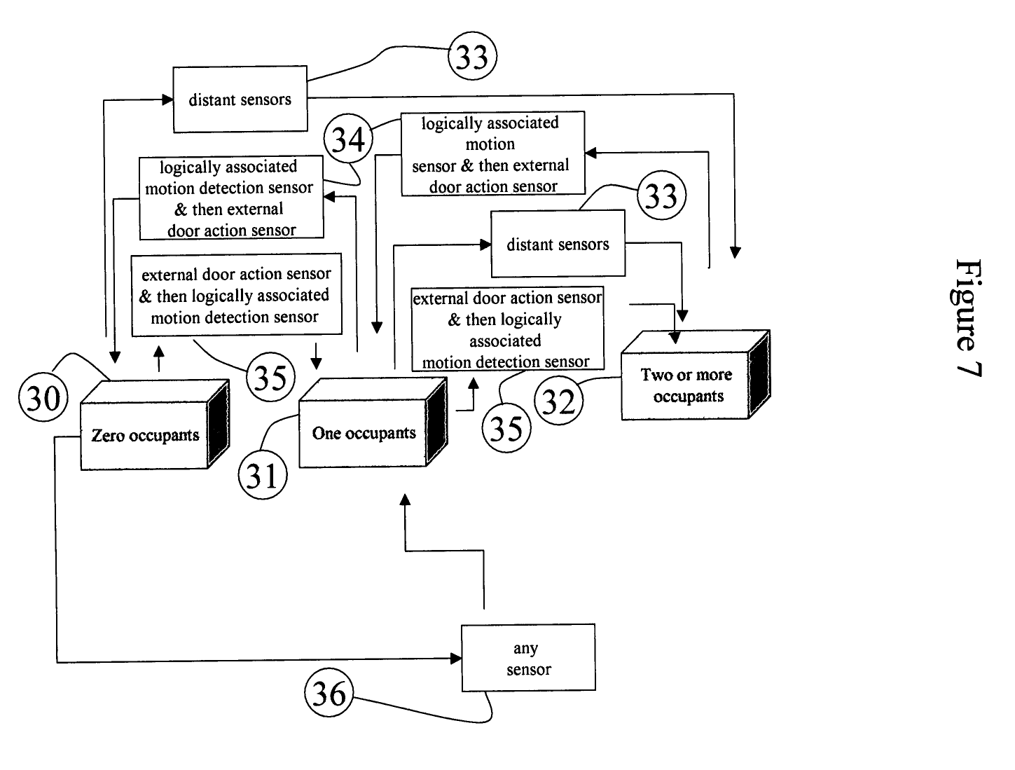

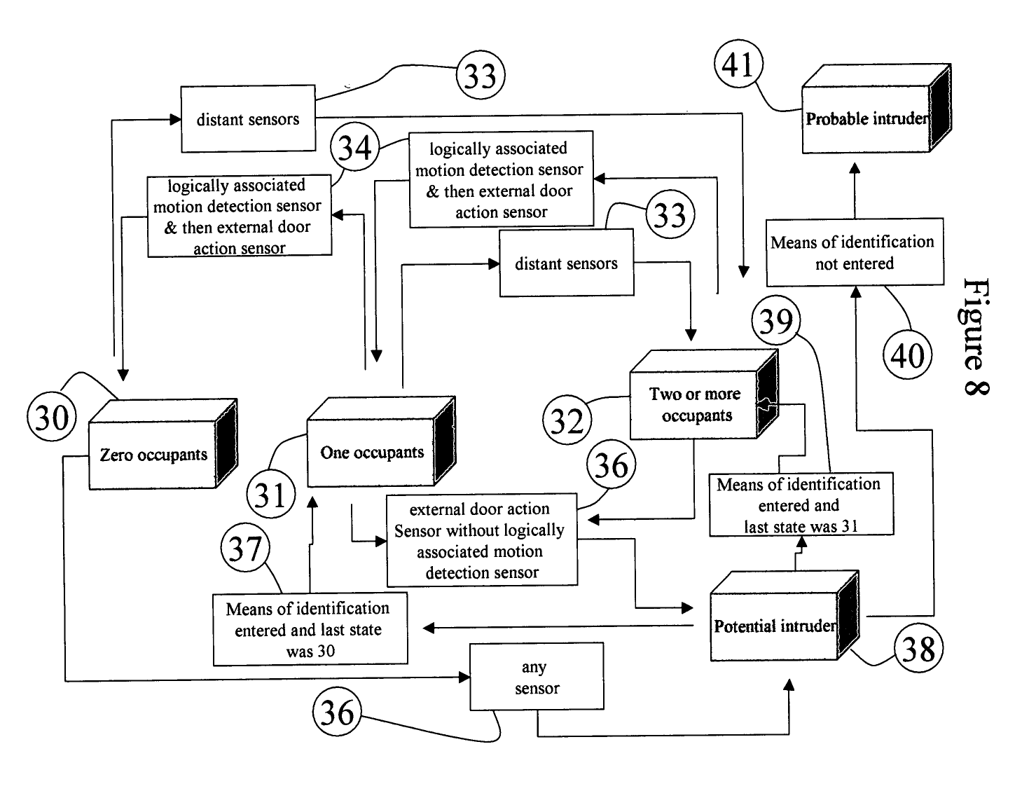

As already mentioned the counting means processing engine 18 runs processes that analyse the activation patterns of the motion detection sensors defined within Table T8, and it computes an occupant count dependent on some simple activation-based rules. Having run these processes to compute the occupant count it then updates fields F148 and fields F149 in Table T7 with the computed values. These aforementioned processes are shown schematically in FIG. 7 and in a preferred and enhanced variant in FIG. 8, and both will now be described in turn.

The process shown in FIG. 7 has three count states that are dependent on motion detection sensor patterns, these states being:
Zero occupant state 30—The space has zero occupants
One occupant state 31—The space has one occupant
Two or more occupant state 32—The space has two or more occupants

Transitions between these various states are caused by motion detection sensor patterns that meet one of the following criteria, although transition between states can also controlled by user intervention via the control means:
Any pair of distant sensors was the last two to be activated. This means at least two people are in the space. This motion detection sensor pattern is represented by box 33 in FIG. 7
A logically associated motion detection sensor was activated and then shortly afterwards an external door action sensor was activated, but this was not followed shortly afterwards by another activation of a logically associated motion detection sensor. This means that at least one person has probably just left the space, and this motion detection sensor pattern is represented by box 34 in FIG. 7.
An external door action sensor has been activated with the activation of a logically associated motion detection sensor just after that, but without a logically associated motion detection sensor having been activated just prior to the activation of the entry or exit door motion detection sensor. This means someone has probably just entered the space, and this motion detection sensor pattern is represented by box 35 in FIG. 7.
Any motion detection sensor has been activated. In the event of a space considered unoccupied this represents that this unoccupied status has now changed. This motion detection sensor pattern is represented by box 36 in FIG. 7.

The process shown in FIG. 7 accesses the data in Table T8 to determine the motion detection sensor relationships. It also requires access to the various instances of Table T3 that stores the data about motion detection sensor activation times. This process ends when it has entered any changes to the occupation level and time of the last automatic count in fields F148 and F149 in Table T7, and when it has transferred any old values from fields F148 and F149 into field F153.

The counting feature of the invention may not be infallible and there are circumstances when a wrong count might be made. Problems due to wrong counting are minimised by having a display which shows the calculated ‘occupant count’ to the occupant, and which can be manually corrected if needed. Problems due to wrong counting are minimised by ensuring a warning is signalled to the occupant at any time that the counting process has calculated that the last occupant is leaving the space.

A slightly more complex counting means processing engine 18 allows occupant counting to be done in this preferred embodiment of the invention where the invention acts additionally as a burglar alarm. This slightly more complex processing engine is shown schematically in FIG. 8, and comprises two additional states, these being:
Potential intruder state 38—A possible intruder has entered the space
Probable intruder state 41—A probable intruder has entered the space

Transitions between these various states are caused by motion detection sensor patterns that meet either one of the criteria just described for the simpler case, or by means of one of the criteria below:
Starting from a state of zero occupants 30, any motion detection sensor has been activated as shown by the box labelled 36. This is indicative that an occupant or an intruder has entered the space
Starting from a state of one occupants 31, any external door action sensor has been activated without there having been an activation of a logically associated motion detection sensor just prior to that. The box labelled 36 represents this event. This is indicative that an additional occupant or an intruder has entered the space.
Starting from a state of potential intruder 38, someone has entered a suitable means of identification. One of the boxes labelled 37 or 39 represent this event, the choice being depending on the occupant count currently in place. The transition is to the ‘one occupant’ state 31 or the ‘two occupant’ count state 32 dependent on the existing occupant count.
Starting from a state of potential intruder 38, the new entrant to the space has failed to enter a suitable means of identification. The box labelled 40 represents this event. The transition is to the probable intruder state 41. In this implementation it is presumed that resolving the situation of the probable intruder takes precedence over the occupant count, and so this is left unchanged until manual intervention changes the state from state 41.

The possible intruder state 38 and the probable intruder state 41 are states that can be used for the purposes of burglar detection.

If the counting means processing engine 18 calculates a new occupant value needs to be stored in field F148 and F149 of table T7 it first transfers the existing values from these fields into field F153. This field F153 stores previous values of the occupant count to facilitate pattern matching.

Having done this the counting means processing engine 18 then updates fields F148 and F149 of table T7 with the newly calculated values of occupant count and time and date, It then compare the times of the automatically counted occupant count and the manually counted occupant count. Depending on the most recent of F148 and F150 it enters a value in field F152 of Table T7, which stores the value of the most recent occupant count.

Means for Preventing False Alarms 8

This means for preventing false alarms 8 comprises the following:
An interface to the counting means 11 such that the table T7 can be ‘read’ by this means for preventing false alarms 8.
An interface to the sensor activation store 3 such that the means for preventing false alarms 8 can write data to the tables within the sensor activation store 3.
An interface to the burglar alarm 13, so that it can communicate to this when the space is unoccupied.
An interface to the clock, so that the clock's value can be read.
Some switch or data input device that allows an occupant to manually enter whether the space is occupied or unoccupied.
A table T9 to store data, as shown below. Table T9 contains three fields F160 to F163, and there purpose is explained within the table.

A ‘means for preventing false alarms processing engine 19’ that manages communication to the aforementioned interfaces.

TABLE T9
Data store for the means for preventing false alarms 9

| | Column where a | | |
|---|---|---|---|
| | value is stored | | |
| Field | (example value | | |
| ID | shown) | Name of Field | Purpose |
| F160 | In, 100336, 2^{nd} | Building | This records if the building is occupied or not, and |
| | December 2003 | occupied/not | has values of ‘In’ or ‘out’. This also records the |
| | | occupied | times and dates of changes of the last change in |
| | | | occupation status. Format is ‘status, hhmmss, date’ |
| F161 | Out, 1, 021312, 2^{nd} | Building | This stores a historic record of previous times that |
| | December 2003 | occupied/not | the building has been left unoccupied or has been |
| | Etc, etc, etc | occupied | re-occupied. Data format is ‘status, hhmmsss, date, |
| | | (historic values) | status, hhmmsss, date, etc’ |
| F162 | In | Occupation status | This has values of ‘In’ or ‘out’. This is used by one |
| | | flag | of the processing engines to recognise when the |
| | | | occupation status in F160 has been changed |

The ‘means for preventing false alarms processing engine 19’ will now be described.

The first process within this processing engine is to determine if an occupant has entered a new value into the switch or data input device. If a new value has been input then this is read and is stored in field F160 of table 9. The second process within the ‘means for preventing false alrms processing engine 19’ is to compare the value stored in field F162 of table T9 and the value stored within fields F148 to F151 of table T7, and to identify which of these holds the most recent value. This most recent value is read to determine the occupation status of the space and then this occupation status is compared to the value stored in field F162 of table T9. If these values are the same (e.g. they both say ‘occupied’) then this process is the last to be done by the ‘means for preventing false alarms processing engine 19’.

If these values are different then the occupation status changed since the last time this process was run. If Field F160 has been changed from ‘in’ to ‘out’ then the ‘means for preventing false alarms processing engine 19’ transfers the values in field F160 into the field F161 so as to save a historic value. It then next changes the value in Field F162 in table T9 to ‘out’ and records the time this change was made. This process then updates fields F166 of table T10 so as to clear out all existing values and replace them with ‘zero’ values.

If Field F160 has been changed from ‘out’ to ‘in’ then the ‘means for preventing false alarms processing engine 19’ transfers the values in field F160 into the field F161 so as to save a historic value. It then next changes the value in Field F160 in table T9 to ‘in’ and records the time this change was made, and changes the value stored in field F162 to ‘in’. This process then updates the fields F166 of table T10, so as to store ‘compensation values’. These compensation values compensate for the reduced motion detection sensor activation level whilst the space was unoccupied, and is intended to prevent false alarms when the space is re-occupied. The method of computing the compensation value is dependent on the ‘units of measure’ by which activation-based rules are defined, this being defined in field F102 of Table T1. Some methods of compensation are described below:
In some cases no compensation is required. An example of this is where there is just one activation-based rule existing within the invention, this rule being is that any motion detection sensor must be activated at least every ten minutes during the daytime. In this example the person will enter the empty space and will start activating motion detection sensors as they move around the space.
In some cases activation-based rules that are defined that require the activation of specific motion detection sensors within a predetermined time interval. A typical example might be where a motion detection sensor in a bedroom has to be activated at least every three hours during the daytime. In this case the compensation involves changing the values stored in field F166 of Table T10 so as to mimic the activation of all motion detection sensors at the time the space was re-occupied. This thus acts to prevent false alarms.
In some cases activation-based rules that are defined require the activation of specific motion detection sensors at a specific frequency, and this frequency is unlikely to be achieved as the space was unoccupied. A typical example is where an activation-based rule specifies a motion detection sensor be activated at least four times within a defined period (say three hours), but the space has been empty for most of that period (say two hours) and no activations had been registered. In this case the compensation involves reading the existing values stored in field F103 and F104 of Table T1, and then calculating a compensating value related to these values and the percentage of the timed period the space has been empty. By way of an example consider the earlier example where a motion detection sensor had to be activated four times in three hours in order to prevent a ‘concern’ alarm, but the space was empty for two hours. In this case this process would calculate that the space had been empty for 67% of the defined period, and would calculate a compensating value such as 67% of four, which was about 2.67. The process would then round this up to three and would store three compensating activations in field F166 of Table T10, on the assumption that the motion detection sensor would have been triggered three times in the unoccupied period.
When ‘adaptive rule setting’ is in use case the compensation involves reading the existing values stored in field F111 and F112 of the various instances of Table T3, and then calculating a compensating value related to these values.

The means for preventing false alarms 8, as just described, provides one way to prevent false alarms when the space are unoccupied or have recently become re-occupied. It will be appreciated that alternative methods of providing a similar function are possible, some of which are simpler. One alternative method would be for this means for preventing false alarms 8 to have a simple switch which recorded if the space was occupied or unoccupied. If the space was unoccupied the means for preventing false alarms 8 could send a signal to the alarm devices 6 so as to disable them. If the space was re-occupied a simple delay device could ensure a signal was sent to the alarm devices 6 for a limited period after the time at which the space was re-occupied, to ensure no alarm could be sent during this limited period.

Comparison Engine 7

The Comparison engine 7 comprises of interfaces to the rules store 5, the sensor activation store 3, the counting means 11, the clock 2, the means for preventing false alarms 8, the control means 9, and the alarm devices 6. The interface to the alarm means 6 contains all the necessary electronic or electrical circuitry to generate signals that can drive the various types of alarms.

The Comparison engine 7 also comprises two tables of data called tables T10 and T11. These are shown below.

TABLE T10
comparison means

| | Actual values calculated by | Compensating values added by | |
|---|---|---|---|
| | ‘Perform maths on registers’ | ‘Means for preventing false | Alarm status |
| Register | routine | alarms processing engine 17’ | flag |
| ID | (Field ID = F165) | (Field ID = F166) | Field ID = F167) |
| R51-DP1 | 3 | 0 | N |
| R51-DP2 | 4 | 0 | N |
| R52 | 7% | 0 | N |
| R53 | 5 | 0 | N |
| R54 | 12 | 0 | N |
| R55 | 12 | 0 | N |
| R56 | 0 | 0 | N |
| R57 | 2 | 0 | N |
| R58 | 2 | 0 | N |
| R58 | 4 | 0 | N |
| R60 | 25 | 0 | N |
| R70 | 3 | 0 | N |
| R71-DP1 | 9 | 0 | N |
| R71-DP2 | 0 | 0 | N |
| R72-DP1 | 1 | 0 | N |
| R72-DP2 | 4 | 0 | N |
| R73 | 2 | 0 | N |
| R74-DP1 | 3 | 0 | C |
| R74-DP2 | 4 | 0 | N |
| R75 | 3 | 0 | N |

The table T10 has a first column that is identical to the first column of Table T1, and it has additional columns given the identifiers of fields F165, F166 and F167. Fields F165 and F166 have contents that relate to the motion detection sensor activations, field F165 containing actual values and field F166 containing values that are calculated as compensating for a period of un-occupation. Field F167 stores a value, called an ‘alarm status flag’, that determines if an alarm will be signalled. This alarm status flag is given a value of ‘N’ (for ‘no danger’) if a neither limit 1 nor limit 2 (in Table T1) has been exceeded, a value of ‘C’ (for ‘concern’) if limit 1 (in Table T1) has been exceeded but limit 2 (in Table T1) has not, and a value of ‘D’ (for ‘danger’) is stored if limit 2 (in Table T1) has been exceeded. The value or values in field F167 are in due course interrogated to determine if an alarm should be signalled.

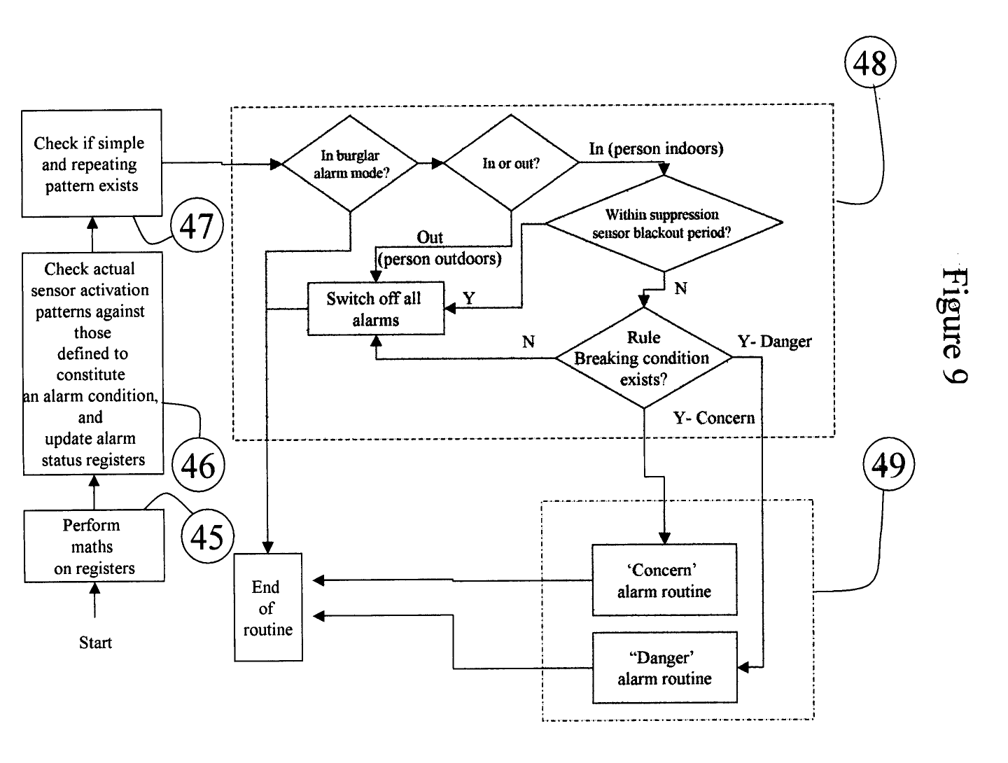

In addition the Comparison engine 7 comprises a Comparison engine processing engine 20 whose function is to determine if any of the activation-based rules within the rules store 5 have been broken and, if so, what type of alarm should be signalled. The processes within this processing engine are shown schematically in FIG. 9, and are described below.

Process 45 in FIG. 9 performs any mathematical operations required to update the values in field F165 of Table T10, this operation being done for every register in that table. The nature of the calculation depends on the units of measure that define an alarm condition, and that are defined by the value stored in the field F102 of Table T1 (the ‘Unit of measure column’) for each register in that table. The mathematical calculation may be to calculate the amount of time since the last activation, the number of activations in the last hour, the number of activations in the defined period, or (if adaptive rule setting is in use) the statistical probability of the last motion detection sensor activation occurring as long ago as it did.

For example, consider a case where adaptive rule setting is in use. If motion detection sensor 1b has not been activated for two hours the mathematical operation would calculate the probability that this delay in activation might happen, based on the past activation record as stored in fields F111 and F112 of the relevant instance of Table T3. The resultant probability value is stored in field F165 of Table T10, in the cell opposite register R52. The calculation in process 45 also takes account of the fact that the space may have been unoccupied for some or all of the defined period, and it does this by including any compensating activation values stored in field F166 of the relevant version of Table T10. As no time and date information is available with the compensating values a time and date can be assigned by assuming these activations were spread evenly during the last period that the space was unoccupied. This information is available via fields F160 and F161 in table T9.

Once the mathematical operations have been done for an individual active motion detection sensor the calculated value is stored in field F165 of Table T10, in the cell that relates to that motion detection sensor and the current defined period. Mathematical operations are done for each individual motion detection sensor in this way, and then the same mathematical operations are done for the groups of motion detection sensors. For example the same probability calculations will be performed for the group of motion detection sensors that are associated due to their being located in toilets, but in this case the activation record from all the motion detection sensors in this group will treated as if they were coming from a single motion detection sensor. The resulting value will then be stored in the field F165 of the appropriate register.

The second process 46 in FIG. 9 compares the calculated values within the fields F165 and F166 of Table T10 with the values stored in the appropriate variant of fields F103 and F104 of Table T1. The appropriate variant of fields F103 and F104 are F103A and F104A, F103A and F103B, F103C and F104C etc, dependent on the current occupant count of the space. For each register the values stored within F165 and F166 are combined together prior to making this comparison. This comparison is a comparison between the defined activation-based rules and the calculated motion detection sensor activations. The values stored within F165 and F166 are combined together prior to making this comparison, so as to make an allowance for any period the space has been unoccupied.

If any activation-based rules have been broken for that motion detection sensor or group of motion detection sensors the value of the alarm status flag in the relevant cell of field F167 of Table T10 is set to ‘C’ for ‘concern’ or ‘D’ for ‘danger’, otherwise the value in field F167 is set to ‘N’ for ‘no alarm’. By way of an example consider a situation whereby no motion detection sensor had been activated in the last three hours during defined period one (register R74-DP1 in table 1), in contravention of the limit defined in field F104 for that register, then the ‘alarm status flag’ for this group of motion detection sensors would be set to ‘C’ to signify a danger situation. Setting field F167 to ‘C’ for register R74-DP1 in table T10 does this. The process 46 ensures that all cells within fields F165 and F166 of Table T10 are compared against the equivalent field F103 and F104 of Table T1, and stores the resultant value in field F167 of Table T10 as appropriate for each register.

Lastly the process 46 needs to check that all relevant sensors were active during the periods to which the various alarm status flags relate. For example, an alarm status flag of ‘D’ for danger could have been set for one particular sensor, but this flag value might be incorrect if the sensor had on recently been added to the system and only recently become active. For each of the registers listed in table T9 the process 46 checks to see if any of the sensors have been inactive for some of the ‘defined period’ in question. T does this by referring to table T1 to find the sensors linked to each register, and then by checking the relevant instance of table T3 to see when the sensors became active. If any registers did not have active sensors for the whole of the defined period the process 46 ensures that the field alarm status flag for the relevant register is set to ‘N’, so as to prevent a false alarm due to a motion detection sensor that has just been added to the system. This part of process 46 that checks the ‘active status’ of motion detection sensors is an optional feature in the preferred embodiment, and is not an essential feature of the invention.

The third process 47 is designed to see if a ‘simple and repeating’ pattern has been signalled at any motion detection sensor, and if so to set a warning flag accordingly. It does this by checking the Historic activation record field F112 for every motion detection sensor to determine if the activation-based rules defined within Table T2 have been met. Process 47 decides to use option A or option B by referring to field F135 in Table T5. If the relevant conditions have been met then the field F167 in Table T11 is set to ‘D’ for danger, otherwise it is set to ‘N’ for no alarm needed.

The fourth process 48 in FIG. 9 analyses the values stored in field F167 of Tables T10 and T11, and decides whether an alarm should be signalled or not. This process 48 is shown schematically in FIG. 9, and has an output that is dependent on the following decisions:
Is the invention operating ‘in burglar alarm mode?’. If so the process ends.
Is the space occupied or not? If the space are unoccupied all alarms are switched off and the process ends.
Has the suppression sensor been activated recently enough that the invention is operating within a blackout period during which all alarm devices 6 should be switched off? If the answer to this is ‘yes’ all alarm devices 6 are switched off and the process ends.
Are the values of F167 of tables T10 and T11 such that an alarm should be signalled. The outputs of this decision can be that a) No illegal condition exists and so all alarm devices 6 are switched off and the process ends, b) a ‘concern’ alarm should be signalled, and so the process next invokes that part of process 49, c) a ‘danger’ alarm should be signalled, and so the process next invokes that part of process 49.

The alarm process 49 in FIG. 9 is not described in detail but is designed to have the following features:
To signal the internal alarm for a short period (for example 30 seconds) before signalling the external alarm, and to cancel the external alarm if any motion detection sensor is activated within the aforementioned short period.
To be able to signal different types of alarm to signify different levels of problem or different types of problem. In this case the alarm process 49 can signal the ‘concern’ alarm or the ‘danger’ alarm as required by process 48.
To exit the routine quickly (whilst leaving the alarm signalling if required) so that ongoing polling of motion detection sensors can continue.
To have a mechanism to reduce the nuisance of the external alarm, in the event of a false alarm not switched off by the occupant.
To be able to signal an alarm in a pulsed manner that is recognisable to people as being an SOS pattern in Morse code. The intent of this feature is to be able to distinguish this type of alarm from a standard burglar alarm.
   Alarm Devices 6

The alarm devices may be one or more devices located inside or outside the space, or a combination of inside and outside. They can be alarm devices that signal an alarm by means of a noise such as a bell or a klaxon, by means of a light, or by some other means such as a vibration. They can also signal an alarm remotely, for instance to a remote telephone. The alarm devices are designed such that they attract the attention of someone who can provide or summon assistance to the occupants or occupants of the space.

Burglar Alarm 13

The burglar alarm 13 as shown herein contains the usual control logic of a burglar alarm, but the other hardware usually associated with a burglar alarm (the sensors, input controls and actual alarm devices) are not provided within burglar alarm 13 as described herein but are instead provided elsewhere with the occupant monitoring system.

Example of the Use of the Occupant Monitoring System as Just Described

This section gives an example of the invention in use within the dwelling shown in FIG. 1, said example being on the 3^{rd} Dec. 2003 when there is one occupant at home. The occupancy level is evident from table T7, which shows that field F150 contains the valid occupant count. Table T9 confirms that the dwelling was occupied at 1003 on Dec. 2^{nd}, 2003.

The last motion detection sensor to be activated was motion detection sensor 1a on 3^{rd} Dec. 2003 at 152003. The occupant unfortunately became unconscious at this time whilst having a wash in the toilet, and fell to the floor.

It has just become 182003 on the 3^{rd} Dec. 2003, and the rule defined in register R74 (for defined period DP1) states that a concern alarm should be signalled if it is 3 hours or more since the last activation of any motion detection sensor. This value of 3 hours is now stored in field F165 of table T10 (against register R74). As no-one has been out recently there are no ‘compensating’ activations to take in to account, and so a ‘C’ value is stored in field F167 of table T10. This initiates a ‘concern’ alarm. The ‘concern’ alarm has been defined such that it will first sound the internal alarm 7a for a period of 30 seconds, to which there is no response. The concern alarm then sounds alarm 7b in ‘concern’ mode. This alarm 7b is an external klaxon, and in ‘concern’ mode this sounds a relatively quiet alarm in an SOS pattern, that brings a neighbour to investigate if all is well.

The neighbour enters the dwelling, activates the suppression sensor to stop the alarms sounding, and then goes to investigate the problem.

The sophistication of the occupant monitoring system may be further enhanced by careful setting of the rules applying within the system so as to ensure detection of a wide range of problems that may arise in the space. One type of problem, for example, that might be detected by the occupant monitoring system is when a sole occupant of a space with multiple rooms is trapped for some reason in one particular room. In this example the sole occupant may be infirm and the door lock may have jammed shut. In this case the occupant may be very mobile within one particular room such that the overall level of sensor activations is not reduced. The rules within the occupant monitoring system could be designed to recognise this problem and to signal an alarm to bring assistance.

In the example system it is further possible that the occupant monitoring system was previously a standard burglar alarm system that was upgraded in situ by the addition of extra or new components to provide the additional logic and hardware required for the occupant monitoring system. With the existing burglar alarm the sensors 1 will already be in situ, and this represents a substantial part of any installation cost. In reality an in situ system upgrade may just be a software upgrade to an existing burglar alarm system or it may require the replacement of one or two system management components at relatively low cost. This opportunity to upgrade an already installed system is potentially very useful to installers of alarm systems. Likewise the system herein described would allow vendors to install a system that could be configured to be a burglar alarm system, and occupant monitoring system or both of these things concurrently. The system installed could be so designed to provide an upgrade or downgrade of functionality with great ease, thus providing increased revenue for the vendor.

It will realised that alternative variants of the above embodiments can be constructed. For example different system architectures can be implemented such that the functionality described herein will be distributed differently. Furthermore it will be realised that it is possible to build occupant monitoring system that are on the one hand large, scale or on the other hand so small scale that they are reduced to one sensor.

One example of an alternative architecture is one in which the motion detection sensors 1 that have some internal logic that intelligently filter out activations that will not provide worthwhile data to the intelligent control unit, perhaps distributing some of the intelligence of the intelligent control unit 14 to the sensors 1 or perhaps giving an opportunity of reducing the complexity of the intelligent control unit 14.

Another example of an alternative architecture is one in which the control means 9 was removed from the intelligent control unit 14 and located in an alternative location.

Another example of an alternative architecture is one where the sensor processing means 7 and the sensor activation store 3 is housed within the various sensors 1 in a distributed manner. Sensors such as this may also have a direct interconnection to the means for preventing false alarms 8.

In such an example it is possible to further design sensor 1 to have further internal intelligence such that each sensor 1 can signal directly to the alarm devices only when one of said sensors 1, modified as described, detects a lack of motion when compared to an expected pattern or rate.

As an example of a much reduced system it is possible that a system can be built with just one detector and with all other system components being built within that one detector housing, whereby a very simple and compact standalone system can be constructed.

The present invention may be embodied in other specific forms without departing from the spirit or essential characteristics thereof. For example, and according to another aspect of the invention, I propose a method of operating an occupant monitoring system to provide an alert on abnormal mobility of a person occupying a space comprising one or more rooms, the method comprising:
detecting motion of the at least one person in the space,
storing data relating to the detected motion of the at least one person,
comparing the data relating to the most recent detected incident of motion with the stored data in accordance with rules defining abnormal motion, in order to identify abnormal mobility of the at least one occupant.
   Therefore, the presently discussed embodiments are considered to be illustrative and not restrictive, the scope of the invention being indicated by the claims.

In summary the invention as described in the above text offers the following features and benefits:

One or more motion detection sensors detect when an occupant or occupants move within a space. The space may consist of multiple different rooms, although the invention will work in a space with one room. One or more of the motion detection sensors used may be of a type that can directly detect a moving body, for example a passive infrared motion detector or a microwave motion detection sensor. One or more of the motion detection sensors used may be of a type that can indirectly detect a moving body, for example a motion detection sensor that detects the opening of a door by someone who is moving. The motion detectors signal motion detection events, although they may be designed so as to do this intelligently. For example they may be provided so as to enforce an upper limit on the rate at which motion detection events can be signalled, thus preventing the system being overloaded with data that imparts little useful information.

It is possible to monitor a normally active person as they walk around a space that contains one or more rooms. In another possible arrangement, an occupant monitoring system according to the invention may be used to detect motion of a stationary person such as a person constrained to bed with a broken leg. In this latter scenario it may be possible to have a number of sensors each of which monitor movement of a different part of a person's body, an example being that one sensor could monitor one arm whilst another monitors the other arm.

The invention enables the motion of one or more occupants of the space in the home or offices to be monitored and an alert to be given upon detection of reduced mobility of one or more of the occupants. This greatly increases the personal safety of the or each occupant and is especially effective for sole occupants of dwellings such as houses and apartments, in particular elderly and infirm people.

The clock provides information about the elapsed time or elapsed time and date since some reference point, or of the actual time or time and date, and this temporal information is distributed throughout the system to those component elements that require knowledge of this information. It is desirable but not essential that the clock that is used is an accurate clock that measures time in days, hours, minutes and seconds.

The sensor activation store keeps a record of at least one activation incident of the or each motion detection sensor, each of which contains at least some reference to the time of a given activation but may be more extensive. For example it can also include an identifier of the motion detection sensor to be activated, or of a group of motion detection sensors of which an activated motion detection sensor is a part. At the very least the sensor activation store stores an activation record of the last activation to occur, but the sensor activation store can store many more activation records than this basic requirement if so desired.

The sensor processing means interfaces to the motion detection sensors such that it can reliably detect when motion is detected by any of the motion detection sensors. Throughout this specification the word ‘interfaces’ refers to an interface that allows information to be passed and so can be an electrical, optical or wireless interface.

The sensor processing means also interfaces to the sensor activation store such that it can create an activation record when an activation of the motion detection sensors that occurs, and such that it can manage the storage of previous activation events, ensuring that at the very least a record of the last activation attempt is retained. The sensor processing means may contain additional software or hardware based logic or analogue hardware that allows it to discard information about activations if this information is unlikely to be of much use to the system, one example being if the information from one particular sensor is coming in at a very high rate. The sensor processing means also interfaces to the clock, so that it can timestamp the activation record if the clock is an elapsed time counter or to provide a time and date stamp if the clock counts time and date.

The rules store is used to store activation-based rules. Depending on the implementation there are one or more activation-based rules operating within the invention. Each of these activation-based rules may relate to designated one or more motion detection sensors. An example of a rule relating to multiple motion detection sensors might be a rule that relates to a group of motion detection sensors, said group being comprised of at least two defined sensors. These activation-based rules are arranged to help detect abnormally reduced or abnormally varied levels of motion by an occupant or occupants of a space comprising one or more rooms such as a home or an office, and are defined such that they help detect abnormally reduced or abnormally varied activation patterns.

The activation pattern may be monitored (as opposed to just the rate of activations or as opposed to monitoring just the time since the last activation of any sensor within the system), thus allowing various scenarios to be covered. For example even if the overall number of activations within a space is at a level that is not abnormal, the activations may abnormally be constrained within one room (for example if an elderly and single occupant was trapped in a bedroom due a malfunction of a lock, and was unable to call for help). The activation-based rules can be configured so as to trigger an alarm in such circumstances. Furthermore the reference to abnormally reduced also ensures coverage of the situation where motion has completely stopped.

The sophistication of the activation-based rules may vary, and at the simplest they may just require that any one motion detection sensor is activated within a predetermined elapsed time. Alternatively more complex activation-based rules can be defined that, for example, take in to account previous activation patterns and that take in to account the time of day, day of the week, and the room in which the occupant is located.

The one or more alarm devices are designed to be able to provide a warning signal to people who can either provide assistance or who can summon assistance. These alarm devices may be located inside the space, located outside the space, or they may be located both inside and outside the space. The alarm devices may be selected from a wide variety of types including sonic alarms, flashing light alarms or alarms that send an electronic message to a remote person.

The comparison engine interfaces to the rules store, the clock and the sensor activation store. This comparison engine compares the activation record to the contents of the rules store, ensuring that the comparison takes account of the current time or time and date information that is provided by the clock. Based on the outcome of this comparison the comparison engine decides whether or not to signal an alarm. If the rules are so defined, it is possible that an alarm can be signalled purely because more time has elapsed since the last activation of one of the motion detection sensors, although more complex rules may well be defined.

The system further includes a means for preventing false alarms. Said means for preventing false alarms is intended to ensure that a false alarm cannot be signalled when the space is unoccupied, and may comprise of a simple on/off switch that directly disables the alarm device(s). Alternatively it may be a more complex component that modifies the behaviour of other components with the occupant monitoring system so as to indirectly prevent an incorrect alarm or alarms. It will be clear that no activations would be expected whilst the space is unoccupied, and so an alarm caused by such an event would be incorrect. Also it will be appreciated that when a space has recently become re-occupied after being unoccupied then it may take a while to re-establish a pattern of motion detection sensor activity that will suppress an alarm. One way that this means for preventing false alarms can prevent false alarms is by being connected directly to the alarm devices such that it can directly stop these signalling a false alarm. Alternatively this means for preventing false alarms can be designed such that it modifies the behaviour of some other part of the system such that false alarms are suppressed. An example of this is that the means for preventing false alarms could modify the contents of the rules store 5 or of the sensor activation store so that an alarm is suppressed. The means for preventing false alarms comprises means for recognising if the home or office is unoccupied or occupied, and it further comprises means for recognising when the space has recently become re-occupied.

The occupant monitoring system may be switched off every time a building is left empty, if the rules are such that they ensure a suitable delay for the first activation to occur.

All variants of the system may include a control means that first allows users to input configuration and control data or signals to any configurable component of said system and that secondly allows users to view the status of the component element of said system and that thirdly stores additional data required for system control.

Any or all of said activation-based rules may be group based rules said group comprising two or more said motion detection sensors from one of a selected set, for example the sets below:
a. constituent motion detection sensors located such that one of these will always be activated if an occupant or occupant visits a toilet or
b. constituent motion detection sensors located such that one of these will always be activated if an occupant or occupant goes for a wash or
c. constituent motion detection sensors located such that one of these will always be activated if an occupant or occupant goes to sleep in any bed in said space or
d. constituent motion detection sensors that are located such that one of these will always be activated if an any of said entry and exit doors is used or
e. all of said motion detection sensors in the system or
f. any other group of said motion detection sensors that helps to ensure the monitoring of a regular daily activity by an occupant or occupants,
   whereby any said group based rule assists in monitoring when key daily functions or routines are not undertaken as per said activation-based rules that are defined.

One of said activation-based rules may be a group based rule comprising of all of said motion detection sensors in the system and said activation-based rule requiring the activation of any two different ones of said motion detection sensors, whereby it is possible to detect situations where an occupant may be abnormally restricted to activating just one of said motion detection sensors.

One or more of the activation-based rules may be adaptive, in that the rule can change dependent on the previous movement pattern of the occupant or occupants of the space. This allows the system to learn about more about the normal behaviour of the occupant or occupants of the space, and hence to recognise better what is reduced motion or abnormal motion. For example the elapsed time since the last activation of one of said motion detection sensors or within a said group may be compared to the activation history for the same, in order to generate a calculated probability of said observed activation delay occurring, and said calculated probability may be compared to one of said activation-based rules that is defined in terms of an activation probability that constitutes a threshold.

The system may further comprise a counting means that allows the entry and subsequent storage of the occupant count for said space, said occupant count being either an automatically calculated occupant count or a manually entered occupant count and said counting means being integrated into said system such that it can modify said time dependent comparison. This allows the occupant counting system to change its behaviour according to the number of occupants within the space, and hence to improve its ability to recognise abnormal behaviour in different situations.

The counting means may further comprise a data store of logically associated motion detection sensors, said logically associated motion detection sensors usually being a pair and comprising firstly an external door action sensor that is one of said motion detection sensors located such that it can detect the opening or closing of one of said entry or exit doors, and secondly comprising a door proximity sensor that is one of said motion detection sensors that is positioned such that it must be activated by someone who is just about to leave or has just entered the space via the entry or exit door monitored by said external door action sensor.

The counting means may further comprise:
a. first means to detect and record if one of said door proximity sensors is activated and then shortly afterwards the said external door action sensor that is logically associated is activated, whereby it is possible to determine with reasonable accuracy if an occupant has left said space and
b. second means to detect and record if one of said external door action sensors is activated and then shortly afterwards if the said door proximity sensor that is logically associated is activated, whereby it is possible to determine with reasonable accuracy if an occupant or occupants have entered said space and
c. third means to detect and record if one of said door proximity sensors is activated and then shortly afterwards the said external door action sensor that is logically associated is activated and then shortly afterwards same said door proximity sensor is activated again, whereby it is possible to determine with reasonable accuracy if occupant or occupants moved to the entry or exit door to open the door for a visitor and then moved away from said entry or exit door.

The counting means may comprise further means to define on or more groups of distant sensors, said distant sensors being motion detection sensors located such that they cannot be activated consecutively by any one occupant without that same occupant activating a motion detection sensor that is not in same said group of distant sensors, whereby consecutive activations by distant sensors identifies situations where two or more occupants are present in said space.

An automatically calculated occupant count can be overridden by said manually entered occupant count if desired and in which said automatically calculated occupant count is:
a) set to one occupant when the system is first operated, or
b) set to two or more occupants if the two or more persons are present in said space, or
c) set to value decreased by one occupant if any said occupant has left said space as detected by said first means, or
d) set to a value increased by one occupant if any said occupant has entered said space as detected by said second means or left unchanged when an occupant has not left said space as detected by said third means.

The counting means may further comprise means to identify a situation in which one of said external door action sensors was the last to be activated and the previous activation in said system was of any of said motion detection sensors except said door proximity sensor that was logically associated or except any other external door action sensor, this situation being where there is likely to be an occupant already in the space and a possible intruder is entering said space.

The system may comprise further means to allow persons in the space to input a means of identification into said system, said means of identification being available only to legitimate occupants of said space, whereby this provides a means for the system to differentiate legitimate occupants of the space from intruders.

The alarm device may signal in a pattern that is recognisable as an SOS message in Morse code, whereby this allows said alarm signals to be differentiated from those of a burglar alarm

The system may comprise further means to enable said system to function alternatively as a burglar alarm when the space is unoccupied.

The system may comprise further means to enable said system to function simultaneously as a burglar alarm, whereby it is possible to concurrently monitor occupant motion and then to detect said possible intruder and whereby it is possible to cancel any warning from said burglar alarm if said means of identification is provided correctly.

The system may further comprise a sensor which is a specially designated sensor or switch that causes the suppression of any alarm generated as a result of any of said activation-based rules being broken, said suppression being for an extended period that is defined so as to reduce the irritation from possible false alarms whilst at the same time providing reasonable monitoring of the well-being of occupants.

One or more of said activation-based rules may apply to a defined period of time or to a specific level of occupant count, whereby rules can be defined such that they vary depending on the time of day or day of the week or such that they can be varied according to occupant count or such that they can be vary depending on both of these things.

Any of said activation-based rules can be subdivided into two or more sub-rules, each sub-rule having a different alarm signalling threshold and each sub-rule being intended to detect a different level of danger to said occupant or occupants.

One of said activation-based rules may recognise a simple and repeating activation pattern generated from any one of said motion detection sensors, said simple and repeating activation pattern being easy for an occupant or occupant to generate but one which is unlikely to be experienced in regular daily life, whereby this allows an easy method for an occupant or occupants to deliberately signal an alarm

Occupant monitoring systems according to any embodiment or aspect of the invention may be adapted from a burglar alarm system, wherein the burglar alarm is suitably adapted so as not to trigger the alarm on detection of a person. This avoids the burglar alarm being set off by a person or persons moving legitimately and normally around the space and the system instead operates as per the occupant monitoring system.

Alternatively the burglar alarm may be modified so as to be able to operate as either a burglar alarm or as an occupant monitoring system, as selected by a legitimate occupant. The burglar alarm system may already be installed in the space, and may be suitably upgraded by means of additional software, hardware or firmware. The adaptation from a burglar alarm to an occupant monitoring as just mentioned may be done by a variety of means depending on the pre-existing burglar alarm design. In some cases the adaptation may require changes to some of the hardware elements of the pre-existing burglar alarm but would normally ensure that the existing motion sensors can be retained. In other cases the adaptation may just require a change to the software operating with the pre-existing burglar alarm, or it may require changes to both some hardware and some software.

A significant benefit of the occupant monitoring system as described is that it allows a way to provide in-situ upgrades to existing burglar alarm systems. Furthermore, the occupant monitoring system may operate in dual mode as a burglar and occupant monitoring system.

In summary, with occupant monitoring systems according to the invention an alarm may be given if occupants of spaces such as homes, hospitals or offices demonstrate varied, reduced or halted motion patterns, whereby an indication is provided of for example illness, injury, death or even being trapped. The logic processing devices allow said system be used to monitor levels of occupant motion by comparing motion detection sensor activation patterns to one or more predetermined activation-based rules, and if any of the activation-based rules have been broken to signal an alarm via the alarm devices. The activation-based rules within the system may be programmed such that they remain constant for at any given time of day, or such that they vary over time depending on previous activation patterns or so that they vary so as change the level of system sensitivity as required by a legitimate occupant of the space.

Occupant monitoring systems according to the invention may provide a passive monitoring system for use within a space, which requires no thought or actions by any one or more occupants and which is able to signal an alarm if the or each occupant display changed patterns of motion caused by possible illness or injury. Such occupant monitoring systems are non-intrusive to the occupants. Furthermore, such systems may not involve the payment of ongoing service fees.

Occupant monitoring systems according to the invention may not significantly impede or interfere with the occupant in their normal daily life, thus making the occupant monitoring system especially acceptable to those people who consider that they do not need such an alarm, such people including the elderly or those with some history of mental illness.

Occupant monitoring systems according to the invention may be left to operate on a continual and long term basis so they may be suitable for monitoring the homes of single people, and especially the elderly or those considered at special risk.

Successful implementations may be constructed without a means for false alarms if that implementation is switched off whenever the space is left unoccupied and if the operating rules allow for a delay so that a valid activation pattern can be re-established on re-entry.

Occupant monitoring systems according to the invention may function successfully even if the occupant or occupants are themselves unable to activate any alarm.

1. A system for the detection and warning of abnormally reduced or abnormally varied mobility by an occupant or occupants of a home or offices and said system being installed in said home or offices and comprising:
one or more motion detection sensors each of which allow detection of motion by said occupant or occupants within or between rooms of said home or offices said detection of motion arising either as a direct result of the motion of a said occupant or occupants or by virtue of the fact that said occupant or occupants has done something that is indirectly indicative of motion within said home or offices, and a clock which provides time data or time and date data that can be distributed to other elements of said system and
a sensor activation store that stores an activation record when said detection of motion occurs said activation record relating to one of said motion detection sensors or a group of said motion detection sensors and comprising at least some reference to time of said detection of motion and said sensor activation store always retaining at the very least data for the latest activation record and a sensor activation store that stores an activation record when said detection of motion occurs said activation record relating to one of said motion detection sensors or a group of said motion detection sensors and comprising at least some reference to time of said detection of motion and said sensor activation store always retaining at the very least data for the latest said activation record and a sensor processing means which first interconnects to said motion detection sensors and said clock and said sensor activation store and which secondly updates said sensor activation store whenever a new detection of motion by any said sensor occurs so as to store at least the latest said activation record to occur and a rules store that stores one or more activation-based rules each of which first relates in some way to the activation history of one or more of said motion detection sensors and each of which is secondly designed so as to identify abnormally reduced or abnormally varied mobility by any said occupant and one or more alarm devices capable of alerting persons who can provide or summon assistance and
a comparison engine that first interfaces to said rules store and said sensor activation store and said clock and that secondly interfaces to said one or more alarm devices and that thirdly makes a time dependant comparison of said activation record with said activation-based rules said time dependant comparison being dependant on the current reading of said clock and having an outcome that results in the signalling of an alarm when any of said rules are broken and a means for preventing false alarms when said home or offices is unoccupied or has recently become occupied said means suppressing false alarms directly by connecting to said alarm devices or indirectly by modifying the behaviour of other component elements of said system and said means comprising input devices or circuitry that provides knowledge that said home or offices are unoccupied or occupied
whereby said system allows the detection of death or debilitating illness or injury of said occupant or occupants and then the activation of said alarm devices so as to attempt to summon assistance.

2. A system according to claim 1 that further comprises a control means that first allows users to input configuration and control data or signals to any configurable component of said system and that secondly allows users to view the status of the component elements of said system and that may thirdly store any additional data required for system control.

3. A system according to claim 1 wherein any or all of said activation-based rules may be group based rules said group comprising two or more said motion detection sensors from one of a selected set comprising either:
a. constituent motion detection sensors located such that one of these will always be activated if an occupant or occupant visits a toilet or
b. constituent motion detection sensors located such that one of these will always be activated if an occupant or occupant goes for a wash or
c. constituent motion detection sensors located such that one of these will always be activated if an occupant or occupant goes to sleep in any bed in said home or offices or
d. constituent motion detection sensors that are located such that one of these will always be activated if an any of said entry and exit doors is used or
e. all of said motion detection sensors in the system or
f. any other group of said motion detection sensors that helps to ensure the monitoring of a regular daily activity by an occupant or occupants,
whereby any said group based rule assists in monitoring when key daily functions or routines are not undertaken as per said activation-based rules that are defined.

4. A system according to claim 1 wherein at least one of said activation-based rules is a group based rule said group comprising of all of said motion detection sensors in the system and said activation-based rule requiring the activation of any two different ones of said motion detection sensors whereby it is possible to detect situations where an occupant may be abnormally restricted to activating just one of said motion detection sensors.

5. A system according to claim 1 which further comprises means to calculate a probability for the delay observed since the latest said activation record said probability being a calculation derived from multiple said activation records that have been retained from the past so as to create a historic record of past activations and said probability then being compared to one or more of said activation-based rules that is defined in terms of a probability that constitutes a threshold, whereby this provides a means of providing adaptive rule setting within said system.

6. A system according to claim 1 that further comprises a counting means that allows the entry and subsequent storage of the occupant count for said home or offices, said occupant count being either an automatically calculated occupant count or a manually entered occupant count and said counting means being integrated into said system such that it can modify said time-dependant comparison or said activation-based rules.

7. A system according to claim 1 which further comprises a data store of logically associated motion detection sensors said logically associated motion detection sensors normally being a linked pair comprising first one external door action sensor that is one of said motion detection sensors located such that it can detect the opening or closing of one of said entry or exit doors and secondly comprising one door proximity sensor that is one of said motion detection sensors that is positioned such that it must be activated by someone who is just about to leave or has just entered the home or offices via the entry or exit door monitored by said external door action sensor, whereby useful data can be obtained about occupants leaving or occupant entering said home.

8. A system according to claim 1 which first comprises a data store of logically associated motion detection sensors said logically associated motion detection sensors normally being a linked pair comprising both one external door action sensor and one door proximity sensor said one external door action sensor being one of said motion detection sensors located such that it can detect the opening or closing of one an external entry or exit door and said one door proximity sensor being one of said motion detection sensors that is positioned such that it must be activated by someone who is just about to leave or has just entered the home or offices via said entry or exit door monitored by said one external door action sensor and which secondly comprises:
a. first means to detect and record if any said one door proximity sensors is activated and then shortly afterwards the said one external door action sensor that is logically associated is activated whereby it is possible to determine with reasonable accuracy if an occupant has left said home or offices and
b. second means to detect and record if any said one external door action sensors is activated and then shortly afterwards if the said one door proximity sensor that is logically associated is activated whereby it is possible to determine with reasonable accuracy if an occupant or occupants have entered said home or offices and
c. third means to detect and record if any said one door proximity sensor is activated and then shortly afterwards said one external door action sensor that is logically associated is activated and then shortly afterwards same said door proximity sensor is activated again whereby it is possible to determine with reasonable accuracy if occupant or occupants moved to the entry or exit door to open the door for a visitor and then moved away from said entry or exit door in order to remain within said home or offices.

9. A system according to claim 1 which at least one of said activation based rules is one that is related to a group of distant sensors said distant sensors being said motion detection sensors located such that they cannot be activated consecutively by any one occupant without that same occupant activating a motion detection sensor that is not in same said group of distant sensors, whereby consecutive activations by said distant sensors identifies situations where two or more occupants are present in said home or offices and whereby it is possible to automatically update an occupant counter that may additionally be present within said system.

10. A system according to claim 1 that further comprises a counting means that allows the entry and subsequent storage of the occupant count for said home or offices, said occupant count being either an automatically calculated occupant count or a manually entered occupant count or an automatically calculated occupant count with a manual override facility and said counting means being integrated into said system such that it can modify said time dependant comparison or said rules.

11. A system according to claim 1 which firstly comprises a data store of logically associated motion detection sensors said logically associated motion detection sensors normally being a linked pair comprising both one external door action sensor and one door proximity sensor said one external door action sensor being one of said motion detection sensors located such that it can detect the opening or closing of one an external entry or exit door and said one door proximity sensor being one of said motion detection sensors that is positioned such that it must be activated by someone who is just about to leave or has just entered the home or offices via said entry or exit door monitored by said one external door action sensor and which secondly comprises a means to identify if said one external door action sensor was activated without the previous activation being that of the said one door proximity sensor to which it is associated or of the same said external door action sensor, whereby this provides a method to inform said system that an intruder may be entering an already occupied home of offices.

12. A system according to any claim 1 in which said alarm device signals in a pattern that is recognisable as an SOS message in Morse code, whereby this allows said alarm signals to be differentiated from those of a burglar alarm.

13. A system according to both claim 1 which firstly comprises a data store of logically associated motion detection sensors said logically associated motion detection sensors normally being a linked pair comprising both one external door action sensor and one door proximity sensor said one external door action sensor being one of said motion detection sensors located such that it can detect the opening or closing of one an external entry or exit door and said one door proximity sensor being one of said motion detection sensors that is positioned such that it must be activated by someone who is just about to leave or has just entered the home or offices via said entry or exit door monitored by said one external door action sensor and which secondly comprises a means to identify if said one external door action sensor was activated without the previous activation being that of the said one door proximity sensor to which it is associated or of the same said external door action sensor, whereby this provides a method to inform said system that an intruder may be entering an already occupied home of offices and which further third comprises a burglar alarm whereby the resultant system can be used as either an occupant monitoring system or as a burglar alarm, or as both these things concurrently.

14. A system according claim 1 which further comprises a suppression sensor which is a specially designated sensor or switch that causes the suppression of any alarm generated as a result of any of said activation-based rules being broken said suppression being for an extended period that is defined such as to reduce the irritation from possible false alarms whilst at the same time providing reasonable monitoring of the well being of occupants.

15. A system according to claim 1 in which one or more of said activation-based rules can apply to a defined period of time or to a specific level of occupant count, whereby rules can be defined such that they vary depending on the time of day or day of the week or such that they can be varied according to occupant count or such that they can be vary depending on both of these things.

16. A system according to claim 1 in which any of said activation-based rules can be subdivided into two or more sub-rules each sub-rule having a different alarm signalling threshold and each sub-rule being intended to detect a different level of danger to said occupant or occupants.

17. A system according to claim 1 is which one of said activation-based rules is designed to recognise a simple and repeating activation pattern generated from any one of said motion detection sensor said simple and repeating activation pattern being easy for an occupant or occupant to generate but one which is unlikely to be experienced in regular daily life, whereby this allows an easy method for an occupant or occupants to deliberately signal an alarm.

18. A system according to claim 1 and adapted from a burglar alarm system, wherein the at least one motion detector will not to trigger the alarm on detection of a person.

19. A system as per claim 1 which is housed in a single enclosure and which comprises a single one said motion detection sensor.

20. A method of operating an occupant monitoring system to provide an alert on abnormal motion of a person occupying a space comprising one or more rooms, the method comprising: detecting motion of the at least one person in the space, storing data relating to the detected motion of the at least one person, comparing the data relating to the most recent detected incident of motion with the stored data in accordance with rules defining abnormal motion, in order to identify abnormal motion of the at least one occupant.

21. A system for the detection and warning of abnormally reduced or abnormally varied motion by an occupant or occupants of a home or offices and said system being installed in a space such as a home or offices and comprising:
one or more motion detection sensors each of which allow detection of motion by said occupant or occupants within or between rooms of said home or offices said detection of motion arising either as a direct result of the motion of a said occupant or occupants or by virtue of the fact that said occupant or occupants has done something that is indirectly indicative of motion within said home or offices, and a clock which provides time data or time and date data that can be distributed to other elements of said system and
a sensor activation store that stores an activation record when said detection of motion occurs said activation record relating to one of said motion detection sensors or a group of said motion detection sensors and comprising at least some reference to time of said detection of motion and said sensor activation store always retaining at the very least data for the latest activation record and a sensor activation store that stores an activation record when said detection of motion occurs said activation record relating to one of said motion detection sensors or a group of said motion detection sensors and comprising at least some reference to time of said detection of motion and said sensor activation store always retaining at the very least data for the latest said activation record and a sensor processing means which first interconnects to said motion detection sensors and said clock and said sensor activation store and which secondly updates said sensor activation store whenever a new detection of motion by any said sensor occurs so as to store at least the latest said activation record to occur and a rules store that stores one or more activation-based rules each of which first relates in some way to the activation history of one or more of said motion detection sensors and each of which is secondly designed so as to identify abnormally reduced or abnormally varied mobility by any said occupant and one or more alarm devices capable of alerting persons who can provide or summon assistance and
a comparison engine that first interfaces to said rules store and said sensor activation store and said clock and that secondly interfaces to said one or more alarm devices and that thirdly makes a time dependant comparison of said activation record with said activation-based rules said time dependant comparison being dependant on the current reading of said clock and having an outcome that results in the signalling of an alarm when any of said rules are broken and a means for preventing false alarms when said home or offices is unoccupied or has recently become occupied said means suppressing false alarms directly by connecting to said alarm devices or indirectly by modifying the behaviour of other component elements of said system and said means comprising input devices or circuitry that provides knowledge that said home or offices are unoccupied or occupied
whereby said system allows the detection of death or debilitating illness or injury of said occupant or occupants and then the activation of said alarm devices so as to attempt to summon assistance.
